(19) United States
(12) Patent Application Publication
(10) Pub. No.: US 2026/0125215 A1
(43) Pub. Date: May 7, 2026

(54) CONTAINER LIFTING MECHANISM FOR A STORAGE AND RETRIEVAL SYSTEM

(71) Applicant: OCADO INNOVATION LIMITED, Hatfield (GB)

(72) Inventors: Jack Meakin, Hatfield (GB); Jason Frankl, Hatfield (GB); Leslie Wynn, Hatfield (GB); Maurice Ballard, Hatfield (GB)

(21) Appl. No.: 19/430,451

(22) Filed: Dec. 23, 2025

Related U.S. Application Data
(63) Continuation of application No. PCT/EP2024/068032, filed on Jun. 26, 2024.

(30) Foreign Application Priority Data
Jun. 26, 2023 (GB) 2309625.8

(51) Int. Cl. B65G 1/04; B66C 1/66; B66C 19/00

(52) U.S. Cl. CPC B65G 1/0464; B66C 1/663; B66C 19/007

(57) ABSTRACT

A robotic load handling device for lifting and moving one or more storage containers stackable in a storage and retrieval system The container lifting mechanism includes: a grabber device comprising a first gripper assembly configured to releasably engage the storage container and a second gripper assembly configured to releasably engage the insert nested within the storage container; at least one actuating mechanism configured to actuate the second gripper assembly independently of the first gripper assembly to separately engage the insert nested within the storage container; and (iii) a drive mechanism configured to raise and lower the grabber device to vertically move the insert out of the storage container to a raised position at which the insert base is above the storage container and to a lowered position at which the insert is nested within the storage container when the second gripper assembly is engaged with the insert.

### CROSS REFERENCE TO RELATED APPLICATIONS

This application is a continuation of International Patent Application No. PCT/EP2024/068032, filed 26 Jun. 2024 and entitled “Container Lifting Mechanism for a Storage and Retrieval System,” which claims priority to United Kingdom Patent Application No. GB2309625.8, filed 26 Jun. 2023 and entitled “Container Lifting Mechanism for a Storage and Retrieval System”; the entire content of each of which applications is incorporated herein by reference.

### FIELD OF THE INVENTION

The present invention relates to the field of automated order fulfilment systems. In particular, the present invention relates to an improved system and method for the handling, or manipulation of storage containers in fully or semi-automated storage and retrieval systems.

### BACKGROUND

Various forms of both fully-and semi-automated order processing and fulfilment systems are known. They, and the various components they comprise, may take many forms.

In some forms of goods-to-man picking systems, for example, bins or other storage containers containing inventory and/or other items may be stored within, and retrieved from, a storage and retrieval system, in order to facilitate picking of items from the storage containers at picking stations. Pallet goods and/or other multi-packs of inbound items are separated and placed, individually or in groups corresponding to their stock keeping unit (SKU) into separate storage containers for storage in the storage and retrieval system.

Storage and retrieval systems typically comprise a three-dimensional storage grid framework structure, within which storage containers/bins are stacked on top of each other, are well known. PCT Publication No. WO2015/185628A (Ocado) describes a known storage and fulfilment system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings.

As shown in FIGS. 1 and 2, stackable containers, known as bins or containers 10, are stacked on top of one another to form stacks 12. The terms “bin”, “container”, “storage container” and “tote” are used interchangeably in this description to refer to the same object. The stacks 12 are arranged in a grid framework structure 14 in a warehousing or manufacturing environment. The grid framework structure is made up of a plurality of storage columns or grid columns 15. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The three-dimensional grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a horizontal plane and supported by the upright members 16. The members 16, 18, 20 are typically manufactured from metal and typically welded or bolted together or a combination of both. The bins 10 are stacked between the members 16, 18, 20 of the grid framework structure 14, so that the grid framework structure 14 guards against horizontal movement of the stacks 12 of bins 10, and guides vertical movement of the bins 10.

The top level of the grid framework structure 14 comprise a track system comprising a plurality of rails or tracks 22 arranged in a grid pattern across the top of the stacks 12. Referring additionally to FIG. 3, the rails 22 support a plurality of load handling devices 30. A first set 22a of parallel rails or tracks 22 guide movement of the robotic load handling devices 30 in a first direction (for example, an X-direction) across the top of the grid framework structure 14, and a second set 22b of parallel rails or tracks 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. As an alternative to the grid framework structure 14 supporting the 2D grid directly on a plurality of upright columns 16 as described with reference to FIG. 1, in other examples the grid framework structure supports the 2D grid on top of a plurality of prefabricated modular panels arranged in a grid pattern, the detail of which is described briefly below and fully in the PCT application, WO2022034195A1, in the name of Ocado Innovation Ltd, and incorporated herein by reference.

FIGS. 4-5 show a known load handling device 30 comprising a vehicle body 32, as described in PCT Patent Publication No. WO2015/019055 (Ocado), hereby incorporated by reference. Each such load handling device 30 only covers one grid space of the related grid framework structure 14. Here, the load handling device 30 comprises a wheel assembly comprising a first set of wheels 34 consisting a pair of wheels on the front of the vehicle body 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. Each of the set wheels are driven to enable movement of the vehicle in X and Y directions respectively along the rails. One or both sets of wheels can be moved vertically to lift each set of wheels clear of the respective rails, thereby allowing the vehicle to move in the desired direction.

The load handling device 30 is equipped with a lifting device (container lifting mechanism) or crane mechanism to lift a storage container from above. The crane mechanism comprises a winch, a tether or cable 38 wound on a spool or reel (not shown) and a grabber device 39. An example of a crane mechanism for lifting and lowering grabber device is described in PCT Patent Publication No. WO2021148657 (Ocado Innovation Limited), hereby incorporated by reference. The lifting device or crane mechanism comprise a set of lifting tethers 38 extending in a vertical direction and connected nearby or at the four corners of a lifting frame 39, otherwise known as a grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2. The grabber device comprises a plurality of grippers that are configured to grip a storage container when actuated by an actuator.

The wheels 34, 36 are arranged around the periphery of a cavity or recess, known as a container-receiving recess or container receiving space 40, in the lower part of the load handling device. The recess is sized to accommodate the container 10 when it is lifted by the crane mechanism, as shown in FIG. 5(a and b). When in the recess, the container is lifted clear of the rails beneath, so that the vehicle or load handling device can move laterally to a different location. On reaching the target location, for example another stack, an access point in the storage system or a conveyor belt, the bin or container can be lowered from the container receiving portion and released from the grabber device.

The container receiving space 40 may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

Upon receipt of a customer order, a load handling device operative to move on the tracks is instructed to pick up a storage container containing the item of the order from a stack in the grid framework structure and transport the storage bin to a pick station whereupon the item can be retrieved from the storage bin. Order picking stations can include various forms of systems for receiving storage containers of items retrieved by the storage and retrieval system so as to enable picking of items therefrom, for placement in delivery containers. Such systems typically include various types and forms of conveyor or trolley-based systems, wherein storage containers are loaded on conveyors or picking trolleys for transport to picking areas for automated and/or manual removal of items and placed in delivery containers, which are often of different type(s) than those used to store items, and which are provided by systems or other sources outside the storage system.

Orders assembled for delivery frequently comprise multiple delivery containers. Individual delivery containers, once they have been suitably filled with picked items, are typically set aside in separate order sortation or handling systems until all required delivery containers for an order or a whole delivery vehicle are ready. At that time the multiple containers required to fill the order are assembled and provided to a dispatch facility for loading or delivery.

Empty delivery containers may be returned, following delivery, to the sorting or dispatch area and fed back into the separate order sortation and handling system for re-use. In other embodiments, delivery containers may be in the form of cartons, which are not returned.

While the use of separate order sortation and handling systems can work well for relatively small installations, handling up to, for example, a few thousand bin retrievals per hour, and either relatively few customer orders per hour or relatively few items per customer order, with large systems, involving tens of thousands of bin retrievals per hour or more, and hundreds or thousands of customer orders, each comprising tens of different items, this can become a bigger problem, requiring extensive conveyor systems for transport and sortation of order containers.

International Application No. WO2014/203126 (Ocado Innovation Limited) teaches a system and method for order processing where a delivery container may be placed inside a storage container to form a storage container combination. The upper edges of the delivery containers do not protrude above the upper edges of the storage containers, when placed therein. This allows the storage container combination to be stored within the grid framework structure. One or more delivery containers can be placed inside storage containers at the dispatch facility or between the dispatch facility and the storage and retrieval system. One or more shopping or other bags may be placed within the delivery containers; and the resulting storage container combination can be placed within the grid framework structure until needed at an order picking station.

At an order picking station, delivery containers within a combination may be stocked with items picked from the same or different storage containers. When all delivery containers associated with an order have been appropriately filled, the storage combination is retrieved by the storage and retrieval system, where it is stored until the appropriate time when it is required for fulfilling an order, at which stage the storage combination is transferred to a dispatch facility. At the dispatch facility, the filled delivery containers are removed from the combinations and loaded or processed for delivery.

To separate the delivery container from the combined delivery container and storage container, typically a load handling device deposits the combined delivery container and storage container onto a transform platform. The delivery container is then secured by clamps, which can travel vertically on a lift mechanism. While the delivery container is secured by the clamps, the transfer platform drop down and moves sideways carrying the storage container away from the delivery container. The clamps can now move down using a lift mechanism and deposit the delivery container to a transfer location where a conveyor or other mechanisms can transfer the delivery container to another location.

Some prior art apparatus, e.g., as disclosed in WO2014/203126 (Ocado Innovation Limited), can combine and separate a delivery container and a storage container, however, such apparatus occupies a significant proportion of the footprint of the related storage and retrieval system, requiring significant alternations to be made to the grid framework structure to accommodate the apparatus.

### SUMMARY OF THE INVENTION

The present invention has mitigated the above problem from the need to have a separate workstation at edge of the grid framework structure to integrating the function of separating and combining the storage container and the delivery container to the container lifting mechanism of the robotic load handling device operating on the grid framework structure. Thus, the operation of separating and combining the storage container and the delivery container can happen in-situ within the grid framework structure rather than requiring a separate peripheral outside of the grid framework structure. Separating the delivery container and the storage container is not limited to being in a load handling device and can be configured as an end effector for a robotic arm. As used herein, the terms “invention” and “the invention” are inclusive (open-ended) and each means (or, is meant to refer to) “one or more embodiments of the present invention,” unless expressly stated otherwise. The present invention thus provides a container lifting mechanism for combining and/or separating an insert and a storage container, said insert comprising an insert base and opposing insert sidewalls extending upwardly from the insert base, the insert being configured to nest within the storage container to define a container unit, the container lifting mechanism comprising: (i) a grabber device comprising a first gripper assembly configured to releasably engage a storage container and a second gripper assembly configured to releasably engage with the insert nested within the storage container; (ii) at least one actuating mechanism configured to actuate the second gripper assembly independently of the first gripper assembly to separately engage the insert nested within the storage container; (iii) a drive mechanism configured to raise and lower the grabber device so to vertically move the insert out of the storage container to a raised position at which the insert base is above the storage container and to a lowered position at which the insert is nested within the storage container when the second gripper assembly is engaged with the insert.

The insert can be a delivery container with a base and four side walls in a box-like structure, or a base with a single pair of opposing side walls, or any other suitable form. In the case where the container lifting mechanism is part of a load handling device operating on a grid framework structure, the plurality of tracks can comprise a first set of tracks extending in a first direction and a second set of tracks extending in a second direction, the second direction being substantially perpendicular to the first direction. The wheel positioning mechanism is, therefore, configured for selectively lowering or raising the first set of wheels or the second set of wheels into engagement or disengagement with the first set of tracks or the second set of tracks. In addition to separating and combining a storage container and a delivery container, the container lifting mechanism of the load handling device can also provide a mechanism for decanting one or more items into the storage containers. To decant one or more items into the storage containers, a specially adapted insert can be provided that can be lifted or lowered in and out of the storage container in much the same way as a delivery container can be lifted in and out of the storage container. The insert can be adapted to allow one or more items to be pushed horizontally into the insert and/or off the insert. The insert comprises an insert base and opposing insert sidewalls extending upwardly from the insert base. The insert may further comprise opposing end walls extending upwardly from the insert base to define a delivery container with a top opening. To enable one or more items to be pushed horizontally onto the insert base and/or off the insert base, the insert may additionally comprise at least one end opening for allowing one or more items to enter and/or exit the insert in a horizontal direction via the at least one end opening. Optionally, the at least one end opening comprises a pair of opposing end openings to define an insert channel for allowing items to enter and exit the insert channel in a horizontal direction. By pushing the one or more items onto the insert base and/or off the insert base removes the need to pick items for transfer into the storage containers. Removing the need to pick items for transfer into the storage containers has benefits as there is no need to take into account how different types of items (which may have different shapes, sizes, weights, fragilities etc.) need to be gripped and lifted in an automated system. There is therefore also no need to provide specialist equipment for picking each different type of item. Therefore, the insert provides a system for transferring different types of items into and/or out of a storage container. Moreover, the at least one end opening also allows access to, and sight of, the items within the container unit from above. This may be useful for systems where the storage containers are used to store products and products are picked out of the storage containers at picking stations to assemble customer orders. Picking is typically done using humans and is increasingly being automated using robotic arms. In both cases, access to and sight of the items from above (e.g. for machine vision systems) may be required.

For the purpose of definition of the present invention, the term “insert” is used to cover the delivery container and insert comprising at least one end openings. In both cases, the insert comprises the insert base and opposing insert sidewalls extending upwardly from the insert base. The insert is adapted to be nested in the storage container. To differentiate between the different types of inserts, the insert for allowing one or more items to be pushed horizontally into the insert comprises at least one end opening and the insert comprising opposing end walls in addition to the opposing sidewalls extending upwardly from the insert base to form an enclosure with a top opening is defined as the delivery container. In both cases, the insert comprises an insert base and opposing sidewalls extending upwardly from the insert base.

To enable the container lifting mechanism to separate and/or combine the storage container and the insert by lifting and/or lowering the insert into or out of the storage container, the grabber device comprises a first gripper assembly configured to releasably engage a storage container and a second gripper assembly configured to releasably engage with the insert nested within the storage container. Optionally, the second gripper assembly may be configured to engage externally of the insert, i.e., the second gripper assembly is configured to approach the outside of the insert when engaging with the insert. Typically, the first gripper assembly engages with the storage container by engaging with one or more cut-outs or openings in the storage container. Similarly, the second gripper assembly engages with the insert by engaging one or more cut-outs or openings in the insert. At least one actuating mechanism is configured to actuate the second gripper assembly independently of the first gripper assembly to engage the insert separately from the storage container when the insert is nested within the storage container. Optionally, the at least one actuating mechanism comprises a first actuating mechanism configured to actuate the first gripper assembly to engage the grabber device with the storage container and a second actuating mechanism configured to actuate the second gripper assembly to engage with the insert. A drive mechanism is configured to raise and lower the grabber device so to vertically move the insert out of the storage container to a raised position at which the insert base is above the storage container and vertically move the insert back into the storage container from the raised position when the second gripper assembly is engaged with the insert.

Optionally, the container lifting mechanism further comprises a control system configured to actuate: (i) the second actuating mechanism independently of the first actuating mechanism to engage the grabber device with the insert; (ii) the first actuating mechanism independently of the second actuating mechanism to engage the grabber device with the storage container.

In order to separate the insert from the storage container, optionally, the control system is further configured to de-actuate (turn off or deactivate): (iii) the first actuating mechanism independently of the second actuating mechanism to disengage the grabber device from the storage container; (iv) the second actuating mechanism independently of the first actuating mechanism to disengage the grabber device from the insert.

Optionally, the at least one actuating mechanism is configured to actuate the second gripper assembly independently of the first gripper assembly to separately engage the insert nested within the storage container. Optionally, the grabber device comprises a lifting frame or mounting frame, and wherein the first and second gripper assemblies are moveably mounted to the lifting frame. To ensure that the second gripper assembly is correctly positioned into alignment relative to the insert, optionally, the grabber device further comprises an alignment mechanism configured to align the second gripper assembly relative to the insert. Typically, the first gripper assembly is guided into engagement with storage container by the lifting frame interacting with the corners of the storage container. For example, the lifting frame comprises one or more locating features, e.g., locating pins, that cooperate with the corners of the storage container to locate the lifting frame in proper alignment with the storage container and to enable the first gripper assembly to properly engage with the storage container. Further detail of locating the lifting frame on the storage container is discussed in WO2021151903 (Ocado Innovation Limited), the details of which are incorporated herein by reference. This interaction of the locating feature with the storage container results in the lifting frame becoming largely immovable relative to the storage container. Thus, to align the second gripper assembly with the insert, optionally, the alignment mechanism operates independently of the at least one actuating mechanism to cause the second gripper assembly to move relative to the first gripper assembly. Having the second gripper assembly be moveable relative to the first gripper assembly and independently of the at least one actuating mechanism enables the alignment mechanism to align the second gripper assembly with the insert prior to the at least one actuating mechanism engaging the second gripper assembly with the insert. Optionally, the alignment mechanism comprises a first set of locating features for guiding the first gripper assembly into alignment with the storage container and a second set of engagement features for guiding the second gripper assembly into alignment with the insert. Since the alignment mechanism operates independently of the at least one actuating mechanism, the alignment mechanism enables the first gripper assembly to move into alignment with the storage container prior to the at least one actuating mechanism engaging the first gripper assembly with the storage container. Similarly, the alignment mechanism operates independently of the at least one actuating mechanism to enable the second gripper assembly to move into alignment with the insert prior to the at least one actuating mechanism engaging the second gripper assembly with the insert.

As the movement of the second gripper assembly when aligning with the insert is different to the movement of the second gripper assembly when engaging with the insert, optionally, the alignment mechanism is configured to move the second gripper assembly relative to the lifting frame along a first direction and the at least one actuating mechanism is configured to move the second gripper assembly along a second direction to engage with the insert, wherein the first direction is different to the second direction. Optionally, the first direction is substantially perpendicular to the second direction.

Optionally, the first gripper assembly comprises a plurality of legs or fingers receivable in one or more openings in the rim of the storage container, each of the plurality of legs comprises a stop engageable with the rim of the storage container. The second gripper assembly can have the same assembly as the first gripper assembly or a different assembly to the first gripper assembly. Optionally, the second gripper assembly comprises a clamping mechanism configured to clamp the insert side walls of the insert nested within the storage container. Optionally, the clamping mechanism comprises a pair of clamps moveable between an engagement position to engage with the insert sidewalls and a disengagement position to disengage from the insert sidewalls. Optionally, the pair of clamps is pivotably mounted to the lifting frame.

To enable the drive mechanism to lift and lower the insert relative to the storage container when the pair of clamps are engaged with the insert sidewalls, optionally, each clamp of the pair of clamps comprises one or more engagement pins receivable in one or more apertures in the insert sidewalls when in the engagement position. To facilitate location of the engagement pins into the one or more of the apertures in the insert sidewalls, optionally, the one or more engagement pins is tapered. Optionally, the leading end of the one or more pins is tapered.

To properly align the one or more engagement pins with the one or more apertures in the insert sidewalls, optionally, the grabber device further comprising an alignment mechanism configured to align the one or more of the engagement pins of each clamp of the pair of clamps with the one or more apertures in the insert sidewalls. Optionally, the alignment mechanism is configured to move the pair of clamps relative to the lifting frame along a longitudinal direction parallel to one of the edges of the lifting frame. By moving along one of the edges of the lifting frame, the one or more engagement pins can be aligned with the one or more apertures in the insert sidewalls. To enable the pair of clamps to be moveable relative to the lifting frame, optionally, the pair of clamps is moveably suspended from the lifting frame. By being moveably suspended from the lifting frame, the pair of clamps can be moved vertically between a raised position and a lowered position. This enables the pair of clamps to move longitudinally along one edge of the lifting frame when in the raised position and locked in position when in the lowered position.

To prevent the insert from moving relative to the lifting frame when the second gripper assembly is engaged with the insert, optionally, the alignment mechanism further comprises a locking mechanism to prevent movement of the pair of clamps along the direction parallel to the longitudinal edge of the lifting frame. Optionally, the locking mechanism comprises a plurality of teeth configured to engage with corresponding teeth on the lifting frame when the drive mechanism raises the grabber device. By being moveably suspended from the lifting frame, the locking mechanism is able to lock the position of the pair of clamps when the pair of clamps is suspended from the lifting frame, i.e. when the drive mechanism raises the grabber device.

Alternatively or additionally, the alignment mechanism is configured to permit the one or more of the engagement pins of each clamp of the pair of clamps to move relative to their respective clamp. Instead of or in addition to clamps moving relative to the lifting frame in order to align the one or more pins with the one or more apertures in the insert sidewalls, the one or more pins can move relative to their respective clamp.

Optionally, the one or more engagement pins of each clamp of the pair of clamps has a cross-sectional shape defined by the intersection of two laterally displaced circles, e.g. having an oval or elliptical cross-sectional shape. The two intersecting circles represent the displacement of the one or more apertures in the insert sidewalls as a result of movement of the insert relative to the storage container when nested within the storage container. For example, where the aperture is a circle, then the displacement of the insert will result in the displacement of the aperture. The insert laterally displaces within the storage container to the extent that the displacement of the apertures in the insert sidewalls overlap to form two intersecting circles. Having an engagement pin having a cross-sectional shape defined by the intersection of two laterally displaced circles increases the chances of the engagement pin being received within the aperture of the insert sidewall.

To engage the pair of clamps with the insert sidewalls, optionally, the at least one actuating mechanism comprises a solenoid or a motor configured to move the pair of clamps between the engagement position and the disengagement position. Optionally, the at least one actuating mechanism further comprises a worm gear comprising a worm screw having at least one groove that meshes with a toothed wheel, and wherein the toothed wheel is driven by the motor to move the pair of clamps between the engagement position and the disengagement position. Optionally, the at least one actuating mechanism comprises a rack and pinion assembly, and wherein the pinion is driven by the motor to move the pair of clamps between the engagement position and the disengagement position.

To mitigate the grabber device failing to grip either the storage container or the insert due to one or more items protruding from the top of the container unit, optionally, the lifting frame having a top side and a bottom side comprises a substantially downwardly extending peripheral wall defining at least one opening extending through the top side and bottom side of the lifting frame. The opening through the lifting frame provides a headroom for any items protruding above the top of the container unit when the grabber device is being lowered towards the top of the container unit.

To reduce the number of mechanisms to actuate the first and second gripper assemblies to engage with the storage container and the insert respectively, optionally, the at least one actuating mechanism is configured to engage the first gripper assembly with the storage container in a first direction of movement of the first gripper assembly and engage the second gripper assembly with the insert in a second direction of movement of the second gripper assembly, wherein the first gripper assembly is coupled to the second gripper assembly such that in the second direction of movement of the second gripper assembly, the first gripper assembly disengages from the storage container and in the first direction of movement of the first gripper assembly, the second gripper assembly disengages from the insert. In other words, the first and second gripper assemblies are coupled such that as one engages, the other disengages. As the first gripper assembly engages with the storage container, the second gripper assembly disengages from the insert. As the second gripper assembly engages with the insert, the first gripper assembly disengages from the storage container. Thus, movement of the first gripper assembly controls movement of the second gripper assembly and movement of the second gripper assembly controls the movement of the first gripper assembly. Coupling or connecting the first gripper assembly with the second gripper assembly removes the need to separately actuate and de-actuate the first gripper assembly in a two-stage process when respectively engaging and releasing the first gripper assembly with the storage container. Similarly, the coupling removes the need to separately actuate and de-actuate the second gripper assembly in a two-stage process when respectively engaging and releasing the second gripper assembly with the insert. This reduces the number of steps required to separate the insert from the storage container.

Optionally, the present invention provides an end effector comprising the container lifting mechanism of the present invention, said end effector is coupled to a robot arm comprising the drive mechanism for combining and separating an insert and a storage container, the insert being configured to nest within the storage container to define a container unit.

Optionally, the present invention provides a robotic load handling device for lifting and moving one or more storage containers stackable in a storage and retrieval system, the storage and retrieval system comprising a grid framework structure comprising a plurality of storage columns for the storage of a plurality of stacks of storage containers and a track system comprising a plurality of tracks arranged in a grid pattern comprising a plurality of grid cells, the track system being arranged above the plurality of storage columns for guiding the robotic load handling device on the grid framework structure, the plurality of the tracks being arranged such that each of the plurality of storage columns is below a grid cell; the load handling device comprising: (a) a wheel assembly comprising a first set of wheels for moving the load handling device on the track system in a first direction and a second set of wheels for moving the load handling device on the track system in a second direction, wherein the second direction is substantially transverse to the first direction; (b) a wheel positioning mechanism configured for selectively lowering or raising the first set of wheels or the second set of wheels into engagement or disengagement with the track system; (c) a container lifting mechanism according to the present invention.

The load handling device according to the present invention can be operable on a grid framework structure to provide a storage and retrieval system comprising: (A) one or more stacks of storage containers, at least one storage container in the stack of storage containers comprising an insert nested in the storage container to define a container unit, said insert comprising an insert base and opposing insert sidewalls extending upwardly from the insert base; (B) a grid framework structure, said grid framework structure comprising: (i) a supporting framework structure comprising a plurality of storage columns, each of the plurality of storage columns being arranged to accommodate a stack of storage containers, at least one storage container in a stack of storage containers comprising an insert nested in the storage container to define a container unit, said insert comprising an insert base and opposing insert sidewalls extending upwardly from the insert base; (ii) a track system comprising a first set of tracks and a second set of tracks, the first set of tracks extending in a first direction and the second set of tracks extending in a second direction, the second direction being substantially perpendicular to the first direction, to form a grid pattern defining a plurality of grid cells, wherein each stack of container units is arranged below a grid cell; (C) one or more load handling devices operable on the track system for lifting and moving storage containers stacked in the stacks, each of the one or more load handling devices comprising a load handling device according to the present invention.

Optionally, the system may further comprise an item moving device associated with at least one of the plurality of storage columns, said item moving device being configured to horizontally move an item onto the insert base via the at least one end opening of the insert by moving the item in the horizontal direction through the at least one of the plurality of storage columns. The at least one of the plurality of storage columns associated with the item transfer device defines a transfer station or merge/separation station for combining and/or separating the storage container and the insert. The transfer station provides an inbound/outbound area of the grid framework structure for respectively conveying one or more items into or out of the grid framework structure. To feed one or more items into the transfer station, the transfer station comprises a first level below the item moving device and a second level associated with the item moving device such that, in use, the item moving device moves one or more items horizontally onto the insert base when the insert is at the second level. The first level enables the container lifting mechanism to lower the combined storage container and insert to a level where the container lifting mechanism can lift the insert out of the storage container to a higher, second level at which the insert base is above the storage container. The second level is at the level to permit the item moving device to move one or more items in a horizontal direction onto the insert base. Optionally, the item moving device comprises a conveyor.

The present invention further provides a method of decanting one or more items into a container unit for storage in a storage and retrieval system according to the present invention, the method comprising the steps of: (a) lowering the container unit down a one of the plurality of storage columns; (b) lifting an insert out of the storage container vertically to a raised position at which the insert base is above the storage container; (c) horizontally moving the item onto the insert base via the at least one end opening when the insert is at the raised position; (d) lowering the insert back into the storage container from the raised position; (e) lifting the container unit above the track system along the one of the plurality of storage columns.

To separate the insert from the storage container, the method may further include steps of: (a) actuating the second gripper assembly to engage the grabber device with the insert; (b) raising the grabber device above the storage container to separate the insert from the storage container.

### BRIEF DESCRIPTION OF THE DRAWINGS

Further features and aspects of the present invention will be apparent from the following detailed description of illustrative embodiments made with reference to the drawings; in general, the same reference numbers will be used throughout the drawings and accompanying written description to refer to the same or like parts; the figures are not necessarily to scale; in the drawings:

FIG. 1 is a schematic diagram of a grid framework structure according to a known system;

FIG. 2 is a schematic diagram of a top view showing a stack of bins arranged within the framework structure of FIG. 1;

FIG. 3 is a schematic diagram of a system of a known load handling device operating on the grid framework structure;

FIG. 4 is a schematic perspective view of the load handling device showing the lifting device gripping a container from above;

FIG. 5 includes views (a) and (b), and shows a schematic perspective cut away view of the load handling device of FIG. 4, showing in view (a) the container receiving space of the load handling device and in view (b) a container accommodated within the container receiving space of the load handling device;

FIG. 6 is a schematic drawing showing the grabber device known in the art seated on the rim of the storage container;

FIG. 7 is a schematic flow diagram illustrating aspect of the order processing system according to an embodiment of the present invention;

FIG. 8 includes perspective views of (a) a delivery container, (b) a storage container, and (c) a combined delivery container and storage container, in accordance with the present disclosure;

FIG. 9 is a perspective view of a known clamping device for separating and merging a delivery container and storage container in a merge/separation station;

FIGS. 10a-10b show perspective views of the grabber device according to an embodiment of the present invention showing the first and second gripper assemblies, where FIG. 10a shows the second gripper assembly in the open configuration; and FIG. 10b shows the second gripper assembly in the closed configuration;

FIG. 10c is a perspective side view of the grabber device according to another example of the present invention spaced apart from the container unit;

FIG. 10d is an enlarged view of the second gripper assembly of the grabber device shown in FIG. 10c;

FIG. 11 includes views (a) and (b), in perspective, showing the grabber device (a) above the container unit, and; (b) engaged to the insert when the insert is separated from the storage container according to an embodiment of the present invention;

FIG. 12 is a flowchart showing the different stages of actuation of the grabber device with the storage container and the insert according to an embodiment of the present invention, where Path A represents the actuation of the 1st and 2nd gripper assemblies for hoisting the insert and Path B represents the stages in the actuation of 1st and 2nd gripper assemblies for hoisting the storage container;

FIG. 13 is a perspective view showing an example of an actuation mechanism for actuating the clamping device of the second gripper assembly according to another embodiment of the present invention;

FIG. 14a is a perspective view showing an expanded view of an insert sidewall being clamped by the clamping device of the second gripper assembly, where the clamp is shown in engagement with the insert sidewall when in the closed configuration; FIG. 14b shows the clamp disengaged from the insert sidewall when in the open configuration;

FIG. 15 is a perspective overhead view of the grabber device showing another example of the second gripper assembly according to the present invention;

FIG. 16 is a perspective view of the grabber device showing the pair of clamps of the clamping device being actuated by single actuator to engage with the insert nested in the storage container according to the present invention;

FIG. 17 is a schematic view of a corner of a container unit showing the separation between the insert and the storage container;

FIG. 18 is a perspective view of the container unit showing a portion of the insert accessible through a cut-out in the sidewall of the storage container extending below the height of the insert together with a magnified (enlarged) view of the opening for receiving the engagement pin of the clamping device in the sidewall of the insert;

FIG. 19, includes views (a) and (b), showing an expanded view of a sidewall of the insert showing the alignment mechanism for aligning the engagement pins of the clamping device with the openings in the insert sidewall, where (a) shows the clamping device disengaged with the insert sidewall, and (b) shows the clamping device engaged with the insert sidewall;

FIG. 20, includes views (a) and (b), showing a perspective side view of the grabber device engaging with the insert, where (a) shows the grabber device above the container unit, and; (b) shows the grabber device engaged with the insert;

FIG. 21 is a schematic overhead view of the grabber device showing the alignment mechanism according to the present invention;

FIG. 22 is an isometric view of a clamp incorporating the alignment mechanism according to an embodiment of the present invention;

FIG. 23 is a schematic drawing showing a cross-section of the engagement pin being received in the opening in the sidewall of the insert;

FIG. 24, includes views (a) and (b), which are schematic drawings showing an engagement pin shared between two intersecting circles, where (a) shows a cross-sectional shape of the engagement pin shared between intersecting circles, and (b) shows an isometric profile of the engagement pin being received in the opening in the sidewall of the insert;

FIG. 25, includes views (a) and (b), which are schematic perspective views of (a) the clamp engaging with the insert according to another example of the present invention, and (b) the clamp engaging with the insert through the cut-out in the storage container;

FIG. 26, includes views (a) and (b), which are schematic drawings showing the engagement of the grabber device with the insert, where (a) shows an exploded view of the grabber device, insert and the storage container, and (b) shows the insert nested within the storage container;

FIG. 27 is a schematic drawing showing another example of the container unit according to the present invention;

FIG. 28 is an isometric view of the grabber device engaging with the insert nested within the storage container shown in FIG. 27;

FIG. 29 is an isometric view of the grid framework structure where at least one of the storage columns is used by the load handling device operable on the grid framework structure to decant one or more items in storage in the grid framework structure;

FIGS. 30a-30d are schematic drawings showing the decant of one or more items into a transfer station incorporated into one of the plurality of storage columns of the grid framework structure, where FIG. 30a shows the container unit lowered to a first level such that the insert base is below the conveyor; FIG. 30b shows the insert base is lifted by the load handling device to a raised position so as to be level with the conveyor; FIG. 30c shows movement of one or more items onto the insert in a horizontal when the insert is in the raised position; and FIG. 30d shows hoisting the container unit up the storage column for storage in the grid framework structure;

FIGS. 31a-31d are schematic drawings showing the stages of decanting one or more items from a conveyor into the container unit, where FIG. 31a shows the lowering of the combined storage container and insert defining a container unit to the first level, FIG. 31b shows the separation of the insert by being lifted by the load handling device such that the insert base is at the raised position; FIG. 31c shows transfer of one or more items onto the insert base when in the raised position; and FIG. 31d shows lowering the insert to recombine with the storage container and hoisting the container unit by the load handling device;

FIGS. 32a-32f are schematic drawings showing the stages in the alignment of the second gripper assembly with the delivery container when engaging with the delivery container, where FIG. 32a shows the grabber device separated from the container unit (combined storage container and delivery container); FIG. 32b shows underneath the grabber device showing the floating second gripper assembly; FIG. 32c shows the grabber device approaching the container unit to engage the delivery container; FIG. 32d shows an expanded view of the interaction of the second set of locating features to align the second gripper assembly with the delivery container; FIG. 32e shows the engagement by clamping of the second gripper assembly with the delivery container; and FIG. 32f shows the separation of the delivery container from the storage container when the grabber device is raised;

FIGS. 33a-33f are schematic drawings showing the stages in the alignment of the second gripper assembly with the delivery container when engaging with the delivery container where the first gripper assembly is coupled to the second gripper assembly, where FIG. 33a shows an exploded view of the grabber device, delivery container and the storage container; FIG. 33b is an end view of the grabber device mounted on the container unit and the second gripper assembly engaged with the delivery container; FIG. 33c shows the delivery container being separated from the storage container when the grabber device is raised; FIG. 33d is an expanded view of the grabber device comprising the first and second gripper assemblies approaching the container unit; FIG. 33e shows the second gripper assembly engaging the delivery container; and FIG. 33f shows the first gripper assembly engaging the storage container.

### DETAILED DESCRIPTION

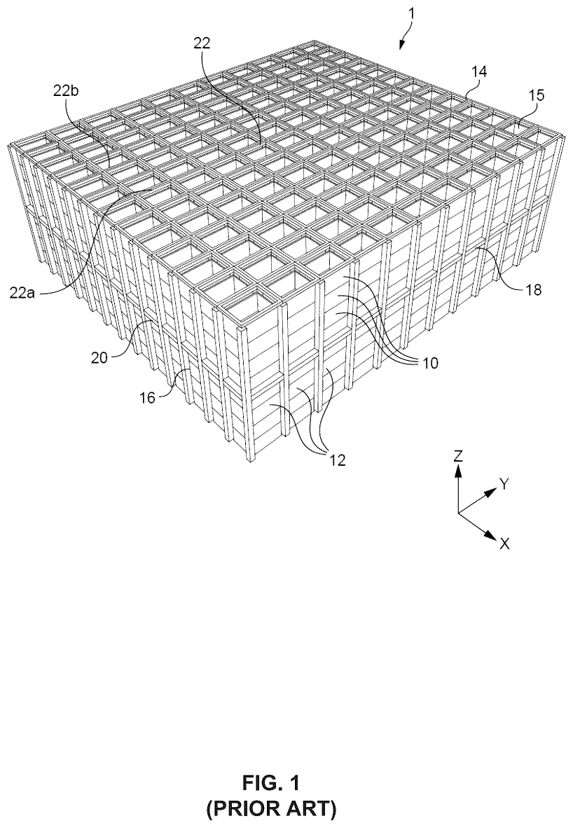

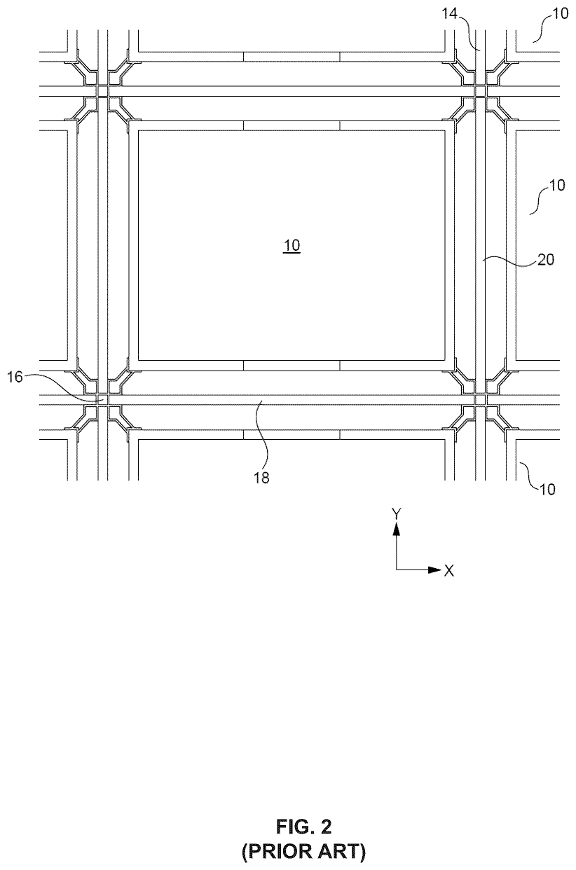

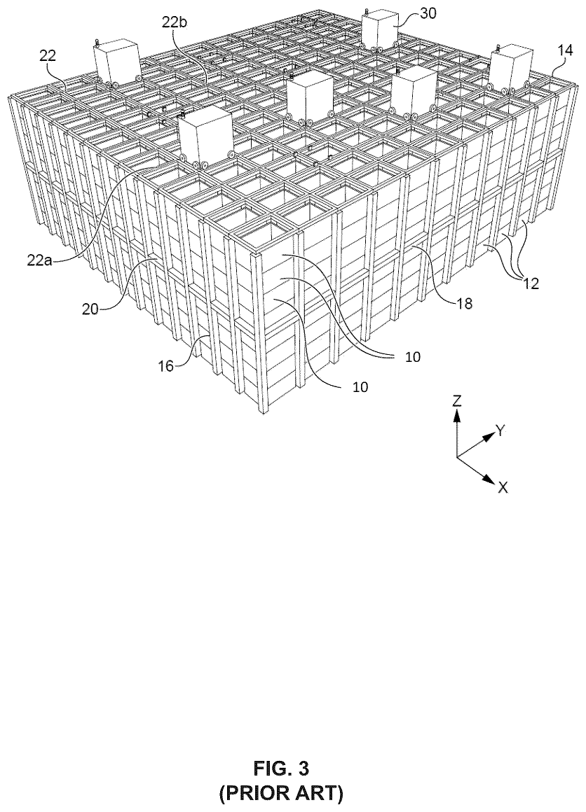

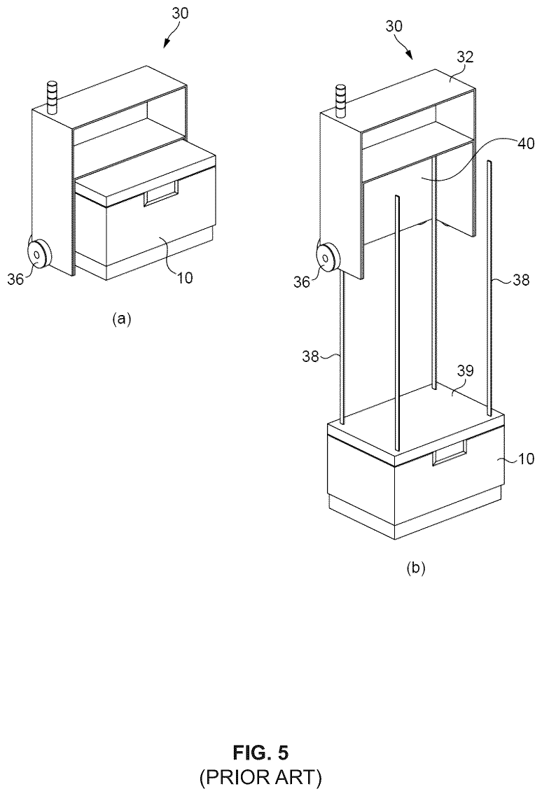

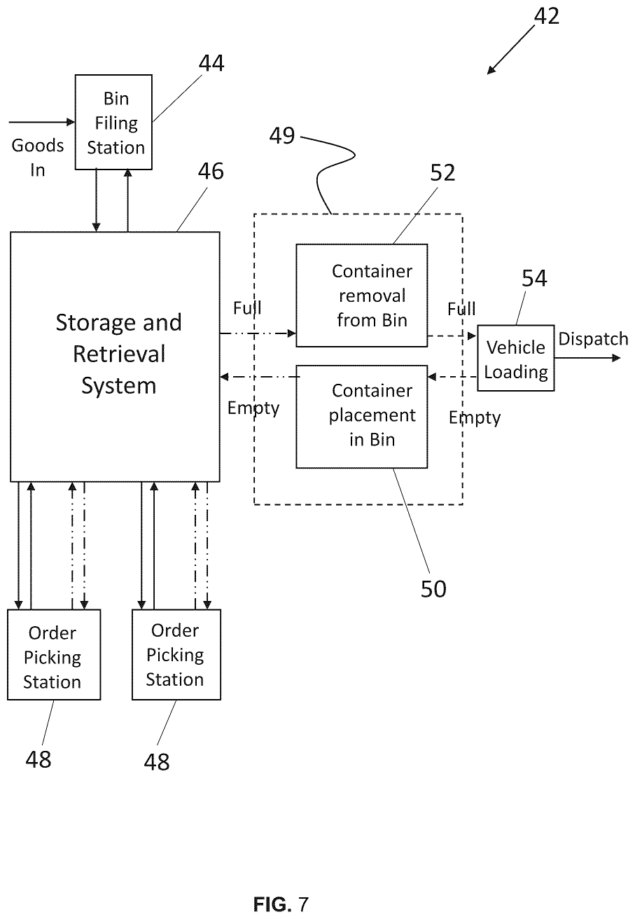

It is against the known features of the storage and retrieval system such as the grid framework structure and the load handling device described above with reference to FIGS. 1 to 5, the present invention has been devised. FIG. 7 shows a schematic flow diagram illustrating aspects of the order processing or fulfilment system 42 according to an example of the present invention. The order processing or fulfilment system 42 is shown to comprise a storage container filling station 44. For convenience, this is known as a bin filling station 44 and enables palleted goods and/or other multi-packs of inbound items to be separated and placed, individually or in groups, into separate storage containers for storage in the grid framework structure. Such re-stocking processes can be performed using any suitably configured fully or semi-automated system(s), using for example various type(s) of conveyors, trolleys, robotic devices etc., and/or can be performed manually by human workers. In various examples, re-stocking stations can include single or plural pick stations wherein one or more palletized, boxed, or otherwise packaged item sets are picked and placed into initially empty or partly filled storage containers. One or more robotic load handling device or load handling devices operative on the grid structure can be instructed to transfer the re-stocked storage container(s) from the bin filling station 44 for storage in the storage and retrieval system 46, more specifically, within a storage column in the grid framework structure. For example, a conveyor system can move the restocked storage container to a suitable location below the grid structure such that a load handling device operative on the grid structure can pick up the restocked storage container and transfer it to a storage column in the grid framework structure until required to fulfil a customer order. For the purpose of the present invention, the grid members comprises tracks or rails arranged in the grid pattern. The tracks or rails can be integrated into the grid members, e.g. by extrusion, or alternatively, secured to the grid members, e.g. by a snap-on (snap-fit) arrangement or use of fasteners. Individual storage containers may be stacked in vertical storage columns, and their locations in the grid framework structure or “hive” may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid framework structure, i.e. the layer immediately below the rail system, Z=2 is the second layer below the rail system and so on to the lowermost, bottom layer of the grid framework structure. A majority of the grid columns in the grid framework structure are storage columns for the storage of storage containers in stacks.

To fulfil a customer order, it is often necessary to retrieve items from multiple storage containers. The order processing or fulfilling system 42 additionally comprises one or more order picking stations 48. Storage containers can be retrieved from the storage and retrieval system 46 and brought to a desired order picking station 48. Specific containers required for fulfilment of orders are accessed by a load handling device operative on the grid framework structure. The load handling device preferably comprises a control system which receives control signals from a radio communications unit of a control system or a central control system concerning information on where to pick up and deliver a storage bin or container in the grid framework structure. The control system controls the operation of one or more load handling devices operative on the grid framework structure and comprises one or more processors, a memory, e.g., read only memory (ROM) and/or random-access memory (RAM, and a communication bus. The memory can be any storage device commonly known in the art and may include is not limited to a RAM, computer readable medium, magnetic storage medium, optical storage medium or other electronic storage medium which can be used to store data and accessed by the one or more processors.

Items picked to a customer order from the retrieved storage containers are placed in delivery containers. To assist with the dispatch of the picked items to a customer order, one or more carrier bags are placed inside the delivery containers such that items picked from one or more storage containers are placed inside the one or more carrier bags. When a delivery container is appropriately filled with ordered items, it can be returned from the picking station to the storage and retrieval system until ready or otherwise required for delivery to a dispatch facility 48 (also termed an “order picking station”).

To return the filled delivery container to the storage and retrieval system 46, typically, the delivery container is placed inside or nested within a storage container to form a delivery container and storage container combination. This allows the storage containers containing the delivery containers to be manipulated by a load handling device operative on the grid structure and be stacked on top of other storage containers in one or more vertical storage columns of the grid framework structure. Suitable configuration of delivery containers for such purposes, by, for example, ensuring that upper edges of the delivery containers do not protrude above the upper edges of the storage containers, when placed therein, can allow the combined delivery container and storage containers to be stored within the grid framework structure.

Although many of the examples described herein refer to a delivery container, the invention is equally applicable to cases where an insert other than a delivery container is nested within a storage container, e.g., an IFCO crate and/or reusable plastic container (RPC).

Returning to the flowchart shown in FIG. 7, one or more empty delivery containers can be placed inside storage containers or bins 50 at the dispatch facility 54 (also termed “vehicle loading” on FIG. 7) or between the dispatch facility and the storage and retrieval system. For example, prior to being transferred to the order picking stations 48, one or more delivery containers may be placed within each storage container and optionally, one or more shopping or carrier bags may be placed within the delivery containers, and the resultant delivery container and storage container combination can be transferred by a load handling device operative on the grid structure to a storage column for storage in the grid framework structure until needed at an order picking station 48. When fulfilling a customer order, the combined delivery container and storage containers are retrieved from storage in the storage and retrieval system by one or more load handling devices operative on the grid structure and transferred to the order picking station 48. At the order picking station 48, delivery containers within a combination may be stocked with items picked from one or more storage containers separately retrieved from the storage and retrieval system. The region of the order or fulfilment processing system 42 for sortation of the delivery container and the storage container is defined as a container sortation system 49 (see dashed box in FIG. 7). The container sortation system 49 includes the apparatus for separating a delivery container and a storage container and combining a delivery container and a storage container. When all delivery containers associated with an order have been appropriately filled, the corresponding delivery container and storage container combination can be retrieved by the storage and retrieval system and either returned to the storage and retrieval system until a scheduled time when the delivery container is ready for dispatch at the dispatch facility or delivered to the dispatch facility 54. At the dispatch facility 54, each filled delivery container can be removed from its combination with its storage container 52 and loaded or otherwise processed for delivery, e.g. loaded into vehicles for dispatch to a customers.

Combining the delivery containers with the storage containers by nesting the delivery container within the storage container provides the advantage that the delivery containers can be manipulated by a load handling device operative on the grid structure and thus, stored in the grid framework structure until required for picking or dispatch at the dispatch facility. In the process of both stocking the delivery containers and transferring the delivery containers for dispatch, it is necessary that the delivery container is both combined with a storage container as well as being separated from a storage container for dispatch. The combination and separation of the delivery container and storage container is traditionally performed by a merge/separation station at the edge or periphery of the grid framework structure, e.g. a combination apparatus for combining the delivery container and the storage container and a separation apparatus for separating the delivery container and the storage container. An example of the merge/separation station is taught in WO2023062233 (Ocado Innovation Limited), the details of which are incorporated herein by reference.

Traditionally, to combine and separate a delivery container and a storage container in the merge/separation station, the merge/separation station comprises a clamping device and a lifting device that is arranged to clamp the delivery container while the storage container is being lifted towards or away from the delivery container. A motorised lifting device is typically used for separating the delivery container and the storage container by raising the delivery container vertically above the storage container or lowering the storage container below the delivery container and/or for combining the delivery container and the storage container by lowering the delivery container into the storage container or raising the storage container towards the delivery container.

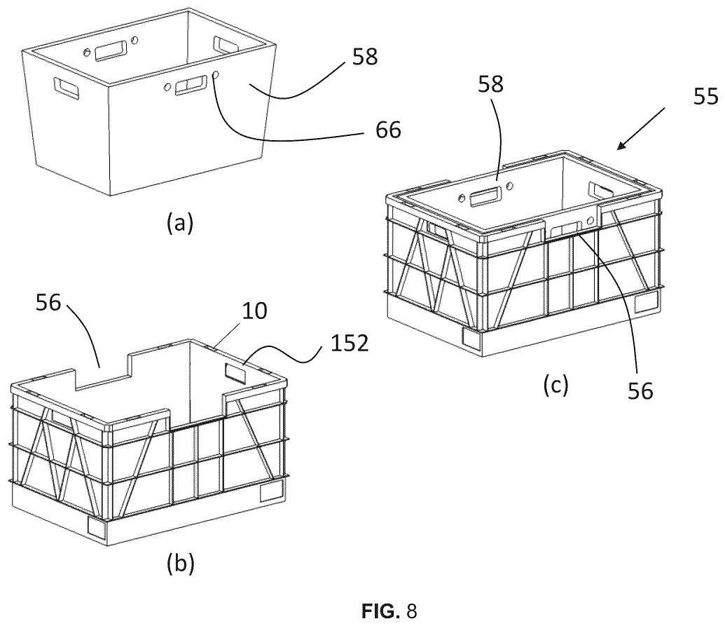

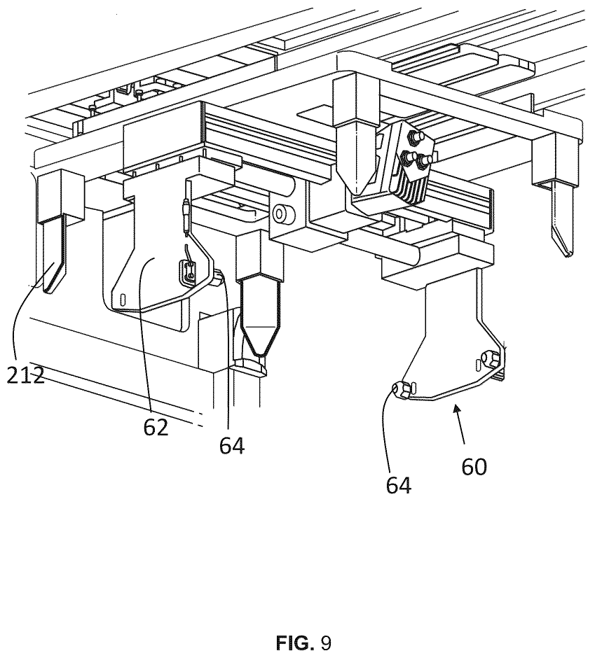

To facilitate easy removal of the delivery container from the storage container, it is necessary that the delivery container is clamped by a clamping device when nested within the storage container. In one example of the present invention shown in FIG. 8(a to c), the storage container comprises one or more cut outs 56 in at least one side wall of the storage container 10 such that when combined with a delivery container 58 as shown in FIG. 8c (i.e. when the side walls of the storage container encircles the delivery container), the cut out 56 extends below the height of the delivery container 58. This enables the clamping device to engage externally of the delivery container. The purpose of clamping the delivery container through the cut outs in the side wall of the storage container is to prevent the clamps from fouling the contents of the delivery container when trying to engage with the delivery container. As the delivery containers stores one or more items for fulfilling a customer order, it is necessary that the clamps do not damage or at least interfere with the contents of the delivery container when trying to engage with the delivery container. In a worst-case scenario, the interference between the contents of the delivery container and the clamps may prevent proper engagement of the clamps with the sidewalls of the delivery container. An example of the clamping device 60 for clamping the delivery container nested within the storage container is shown in FIG. 9, and comprises two clamps or paddles 62 that are configured to clamp opposing side walls of the delivery container through the cut outs 56 of the storage container. In operation, the clamping device 60 in an open configuration is placed around the opposing side walls of the delivery container in the area where the cut out 56 of the storage container extends below the height of the delivery container 58. In the open configuration of the clamping device, the two clamps 62 move apart so as to enable the clamping device 60 to be placed around the opposing side walls of the delivery container 58. Once placed around the opposing side walls of the delivery container 58, the clamping device 60 is instructed by the control system to clamp onto the opposing side walls of the delivery container in a closed configuration. Movement of the clamping device outwardly to engage with the delivery container and inwardly to engage with the delivery container can be carried out by a suitable actuating mechanism, e.g. a linear actuator. Optionally, the clamp device comprises engagement features 64 that engage with corresponding engagement features 66 in the delivery container 58 so that when clamped, the delivery container 58 is held by the clamping device 60 when it is being combined with or separated from the storage container 10. In the particular embodiment of the present invention shown in FIG. 9, the engagement features 64 of the clamping device comprise one or more pins 64 that are received in corresponding openings 66 in the delivery container 58 (see FIG. 8a) when the clamping device clamps onto the sidewall of the delivery container.

The various stations of the order processing and fulfilling station discussed above, namely, the bin filling station 44, the order picking station 48 and the container sortation station 49, are typically located at the edge or periphery of the grid framework structure (hence, the terminology used in the art to described such stations as “peripherals”). Not only does the addition of various stations around the periphery of the grid framework structure increase the footprint of the fulfilment centre thereby reducing the storage capacity of the grid framework structure for accommodating additional storage columns but it also increases the complexity to process and fulfilling customer orders.

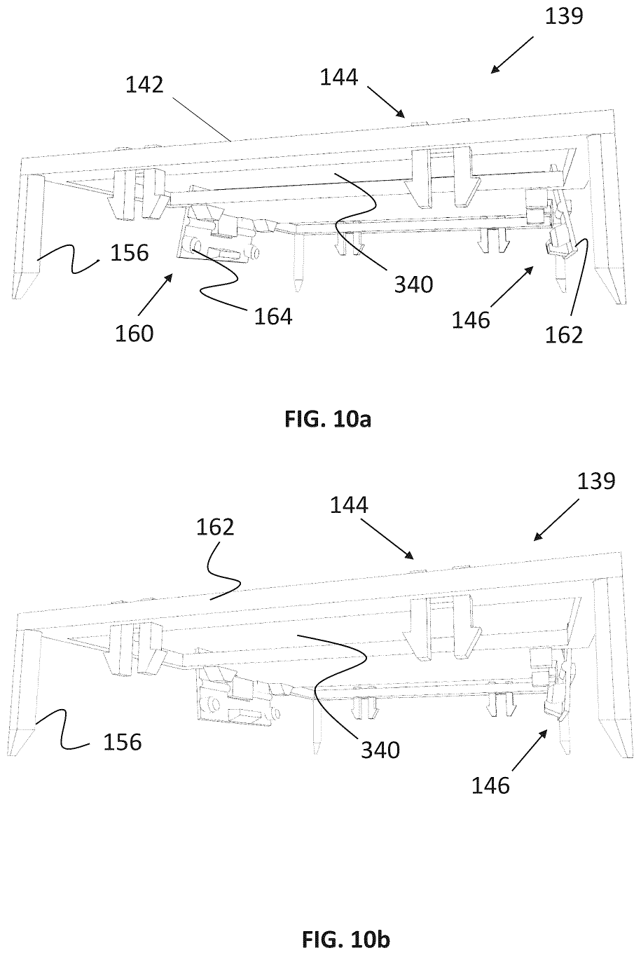

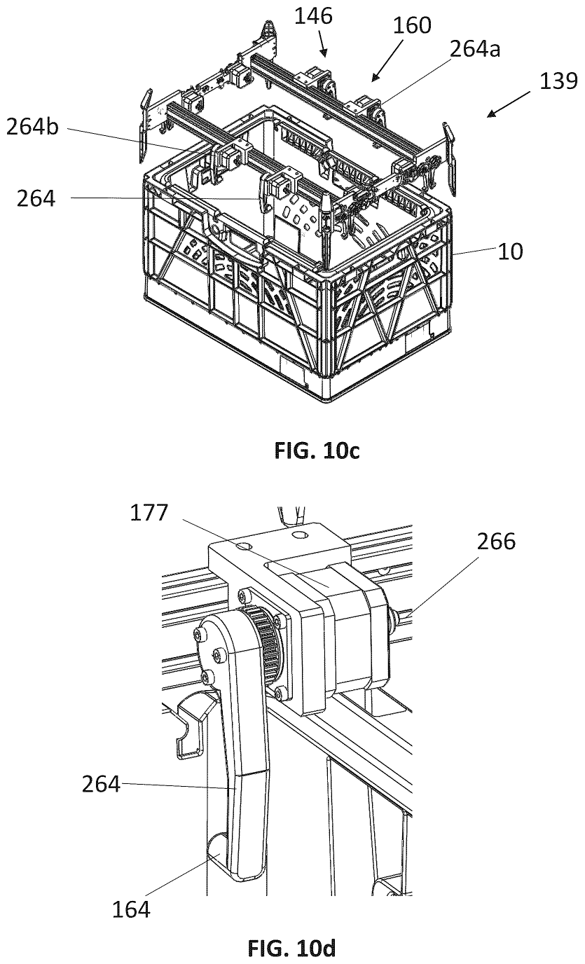

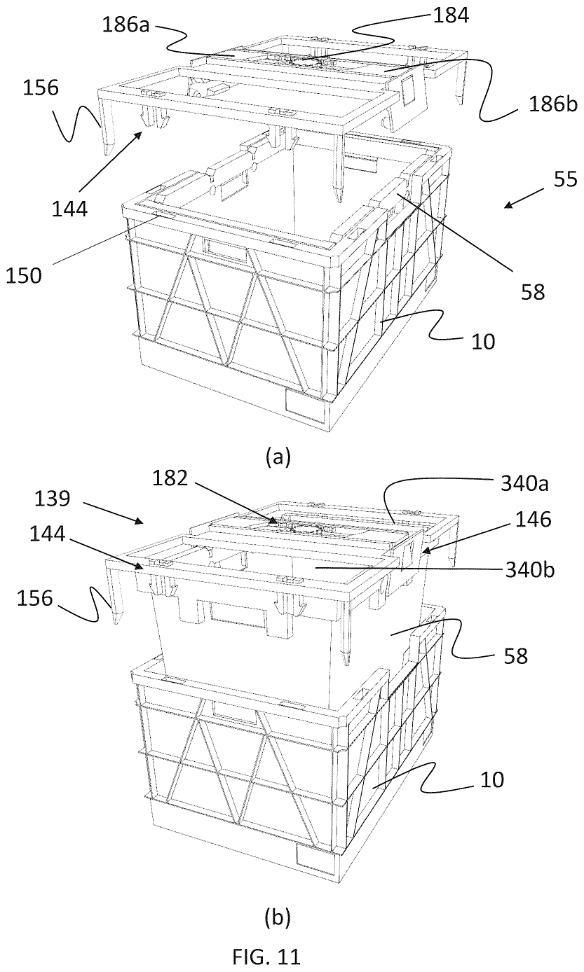

To mitigate the above problem, one or more operations of the order processing and fulfilling station is transferred to one or more robotic load handling devices operable on the grid framework structure. In the particular example of the present invention, the operation of separating and combining the delivery container and the storage container is transferred to the container lifting mechanism. The container lifting mechanism, more specifically, the grabber device, is specially adapted to not only engage with the storage container but also engage with the delivery container. As a result, the operation for separating or combining the delivery container and the storage container can be carried out in situ on the grid framework structure rather than a separate station at the periphery of the grid framework structure. To engage the grabber device with the storage container and the delivery container, the grabber device 139 comprises a lifting frame 142, a first gripper assembly 144 for engaging with the storage container 10 and a second gripper assembly 146 for engaging with the delivery container 58 (see FIG. 10(a and b)). At least one actuating mechanism can be configured to separately actuate the first gripper assembly 144 and the second gripper assembly 146. However, it is not necessary that the second gripper assembly 146 is adapted to engage with the delivery container 58. It is perfectly feasible that the second gripper assembly 146 can be adapted to engage with any type of insert that is configured to nest within the storage container. The term “insert” will be used in this specification to refer to an insert comprising an insert base and opposing sidewalls. For the purpose of explanation of fulfilling customer orders, the insert will be described with reference to the delivery container. The term “container unit” 55 in this specification is used to refer to the combination of the insert nested within the storage container. Further details of the different types of actuating mechanisms for actuating the gripper assemblies are discussed below.

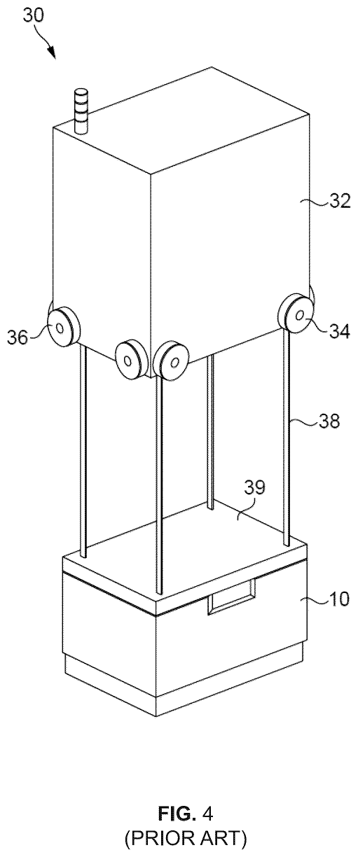

The container lifting mechanism used to lift the storage containers into the container receiver portion can take any suitable form. For maximum stability and load capacity, commonly four lifting tethers 38 are used to winch the grabber device 39, with one tether disposed nearby or at each of the corners of the grabber device 39 (as shown in FIG. 4), but a different arrangement, for example with fewer tethers, could be used if desired. One end, e.g. first end, of each of the tethers is wound on the spool in the load handling device and the other end, e.g. second end, is fixed to the grabber device 39, typically at each corner of the grabber device, by a suitable bracket (not shown). Commonly, the tethers are composed of stainless steel but other materials with the above properties are permissible in the present invention. A pulley system taught in the art, WO/2021/148657 (Ocado Innovation Limited), the details of which are incorporated herein by reference, may be used to reduce the force required to lift and lower the grabber device relative to the body of the load handling device. For example, the raising and lowering of the grabber device may comprise a plurality of spools, each spool of the plurality of spools carrying a lifting tether having a first end anchored to the grabber device and a second end anchored to the spool. A drive mechanism raises and lowers the grabber device relative to the body of the load handling device. For example, the plurality of spools may be driven a single motor via a plurality of timing pulleys, timing belts, and/or gears to raise and lower the grabber device. It will be appreciated that the drive mechanism is not limited to a single motor taught in WO/2021/148657 (Ocado Innovation Limited) and can comprise more than one motor for driving the plurality of spools to lift and lower the grabber device. For example, each of the plurality of spools carrying the lifting tethers may be driven by separate motors. When engaged with a storage container, the drive mechanism raises and lowers the storage container along a storage column of the grid framework structure.

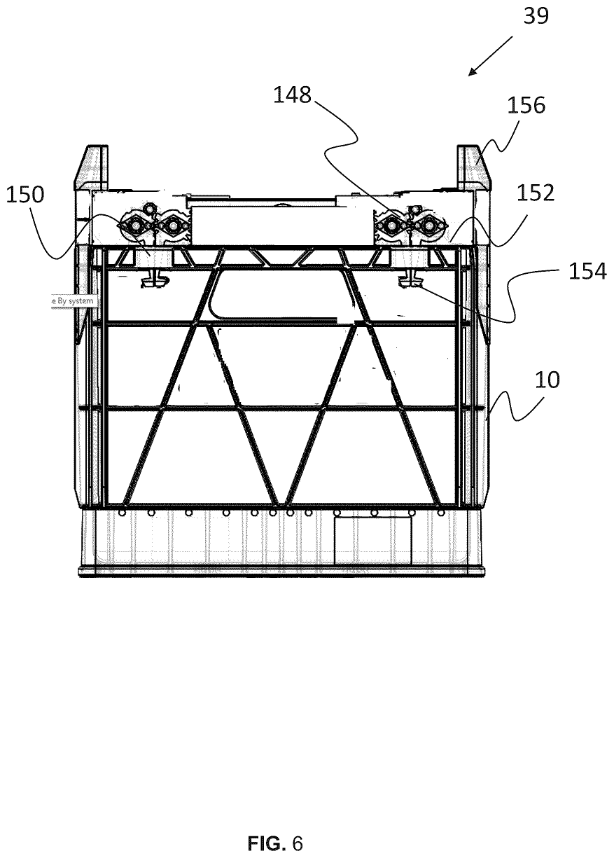

It will be appreciated that different types of gripper assemblies known in the art can be used for releasably engaging with the storage container and the delivery container combination. For example, the first gripper assembly for releasably engaging with the storage container can be based on the gripper assembly taught in the art, WO 2021/151903 (Ocado Innovation Limited), and comprises four gripper elements protruding downwardly from the lifting frame to engage with one or more openings in the rim of the storage container. Each of the gripper elements comprises a pair of wings or legs 146 that are collapsible to be receivable in corresponding holes 150 in the rim 152 of the storage container and an open enlarged configuration having a size greater than the width of the holes 152 in the rim of the container in at least one dimension so as to engage with the storage container (see FIG. 6). The wings are driven into the open configuration by a drive gear driven by a suitable actuator, e.g. solenoid. More specifically, the head of at least one of the wings comprises a plurality of teeth that mesh with a suitable drive gear such that when the gripper elements 148 are actuated, rotation of the drive gear causes the pair of wings to rotate from a collapsed configuration to an open, enlarged configuration. When in the collapsed or closed configuration, the gripper elements 148 are sized to be receivable in corresponding holes or openings in the rim of the storage container as shown in FIG. 6. The foot of each of the pair of wings comprises a stop 154, e.g. a boss, such that when received in a corresponding hole 150 in the rim of the container, the stop 154 engages with an underside of the rim 152 when the gripper elements are in an enlarged open configuration to lock onto the storage container when the grabber device 139 is winched upwards towards the container-receiving portion of the load handling device.

It will be appreciated that the first gripper assembly 144 is not limited to the gripper legs shown in FIG. 6 and can be based on any type of gripper assembly that is configurable to releasably engage with the storage container. For example, the first gripper assembly can be based on a twist lock mechanism that is configured to be rotated about a substantially vertical axis to releasably engage with the storage container as taught in the art, WO/2022/058554 (Ocado Innovation Limited), the details of which are herein incorporated by reference.

To properly engage with the storage container, the grabber device 39 in the art additionally comprises one or more guide or locating pins 156 protruding downwardly from the lifting frame 142 for guiding the lifting frame vertically within the storage column of the grid frame structure relative to the storage container (see FIG. 6). The one or more guide or locating pins 156 not only ensure that the grabber device 39 is guided along the storage column but also ensure that the gripper elements 148 are properly aligned with the rim 152 of the storage container, more specifically the openings 150 in the rim 152 of the storage container. In the particular embodiment of the present invention shown in FIG. 6, the grabber device 39 comprises four guide or locating pins 152. The guide pins 152 are located in the respective corners of the lifting frame 142 and extend downwardly from the lifting frame 142. In the particular example of the lifting frame shown in FIG. 6, the lift frame 142 is substantially rectangular to engage with a substantially rectangular the rim 152 of the storage container 10. However, the present invention is not limited to the lifting frame 142 being substantially rectangular and can be any shape, e.g. square, to engage with the rim of the storage container. Once located at the corners of the storage container, the lifting frame 142 is prevented from moving in a horizontal plane relative to the storage container.

An example of the grabber device 139 that is specially adapted to separately engage with the storage container and the delivery container when nested in the storage container is shown in FIG. 10(a and b). Like the grabber device used in the art to releasably engage with the storage container, the grabber device 139 according to the present invention comprises a lifting frame 142 supporting the first gripper assembly 144 that is configured to engage with the storage container and the second gripper assembly 146 that is configured to engage with the delivery container. In the particular embodiment of the present invention shown in FIG. 10(a and b), the first and second gripper assemblies 144, 146 are mounted to a single lifting frame 142. The first gripper assembly 144 can be based on the gripper assembly discussed above for engaging with the storage container (see FIG. 6). Like the combined/separation station discussed above, the second gripper assembly 146 comprises a clamping mechanism or clamping device 160. In the particular example shown in FIG. 10(a and b), the clamping device comprising a pair of clamps 162 that are configured to clamp the sidewalls of the delivery container through one or more cut-outs in the sidewalls of the storage container. It will be appreciated that the second gripper assembly 146 does not need to be limited to a clamping mechanism discussed above and can have similar engagement features as the first gripper assembly 144. Equally, the clamping mechanism is not limited to having a pair of clamps and can have any number of clamps with the functionality of clamping the sidewalls of the delivery container. For example, the clamping device or clamping mechanism 160 can comprise a plurality of arms or fingers 264 mounted on a rotatable shaft 266 such that rotation of the shaft 266 moves the plurality of arms or fingers 264 from a closed configuration to engage with the sidewalls of the delivery container 58 through the cut-out 56 in the sidewalls of the storage container 10 and an open configuration to disengage from the delivery container 58 (see FIGS. 10c and 10d). In the particular example of the present invention shown in FIG. 10c, the plurality of arms or fingers 264 comprises a first set of arms or fingers 264a and a second set of arms or fingers 264b, each of the first and second sets of arms or fingers 264a, 264b being rotatable on their respective rotatable shafts 266. The rotatable shafts 266 are rotatably mounted to the lifting frame and configured to cause the first and second sets of arms or fingers 264a, 264b to engage externally of the delivery container sidewall. For the purpose of explanation of the multi-purpose grabber device of the present invention, the second gripper assembly 146 will be described by reference to the clamping mechanism that is configured to engage the delivery container through the cut-outs in the side walls of the storage container. The advantage of the clamps in contrast to other forms of the second gripper assemblies is the ability to approach the delivery container externally of the delivery container and therefore, mitigating the need to interfere with the contents of the delivery container.

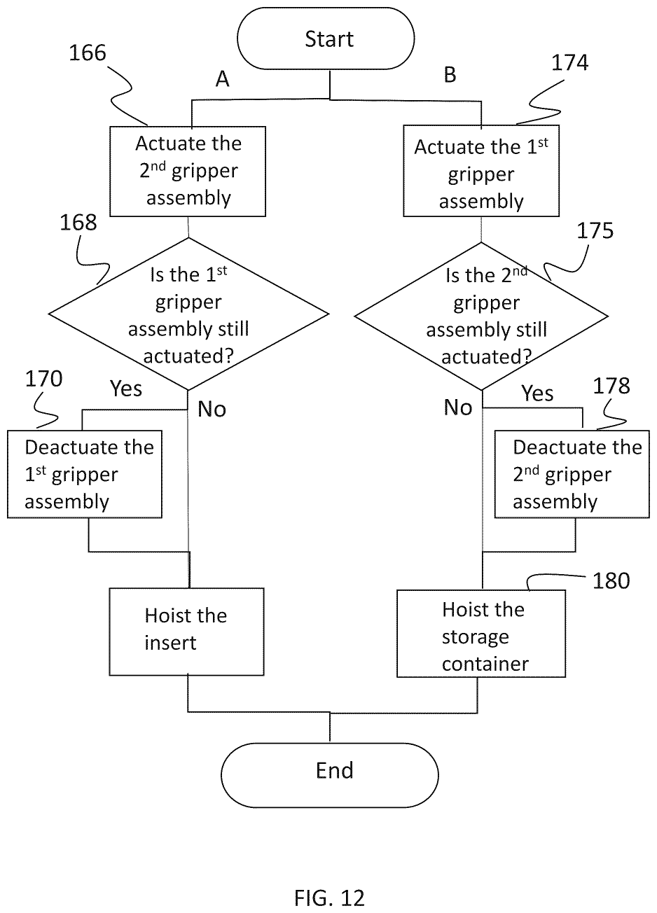

In the particular example of the present invention shown in FIG. 10(a and b), the clamping mechanism comprises a pair of clamps 162 that are pivotally mounted to the lifting frame 142 having an open configuration to enable the delivery container to be inserted between the pair of clamps when the grabber device is lowered onto the storage container (see FIG. 10a and FIG. 11a) and a closed configuration to physically engage with the delivery container through the cut-outs in opposing side walls of the storage container (see FIG. 10b and FIG. 11b). Like the pair of clamps in the merge/separation station, the pair of clamps are configured to engage the delivery container externally of the delivery container so as to prevent the clamps from interfering with the contents of the delivery container when the lifting frame is lowered onto the storage container. To properly engage with the delivery container each of the pair of clamps 162 comprises one or more engagement pins 164 that are sized to be received in one or more openings 66 in the side walls of the delivery container when the pair of clamps 162 are in the closed configuration. In the particular example shown in FIG. 10(a and b), each of the pair of clamps 162 comprise a pair of engagement pins 164 that are spaced apart corresponding to the spacing between the pair of openings in the sidewall of the delivery container such that when the pair of clamps is in the closed configuration, the pair of engagement pins 164 are received in the pair of openings in the sidewall of the delivery container. In the case where the clamping device 160 comprises a plurality of rotatable arms or fingers 264 as shown in FIGS. 10c and 10d, each of the plurality of rotatable arms or fingers 264 comprise the engagement pin 164 receivable in respective openings in the sidewall of the delivery container. The plurality of arms or fingers engages with the sidewall of the delivery container when their respective engagement pins 164 are received in openings in the sidewall of the delivery container. The plurality of arms or fingers 264 are spaced apart on the rotatable shaft 266 such that the spacing of the engagement pins correspond to the spacing of the openings in the sidewall of the delivery container. The engagement pins 164 are received in the openings in the sidewall of the delivery container when the plurality of arms or fingers are rotated towards the sidewall of the delivery container in one direction (first rotational direction) and disengage or withdraw from the openings when the plurality of arms are rotated in the other direction (second rotational direction); the first rotational direction being different to the second rotational direction. Rotation of the plurality of arms or fingers 264 is effected by rotation of the shaft 266. For example, to engage with the delivery container, the first set of arms or fingers 264a rotate in a clockwise direction and the second set of arms or fingers rotate in an anti-clockwise direction.

To separately engage the grabber device with the storage container and the delivery container, the at least one actuating mechanism is configured to actuate the first gripper assembly 144 independently of the second gripper assembly 146 and second gripper assembly 146 independently of the first gripper assembly 144. A control system comprising a processor and a memory storing one or more computer executable instructions, when executed by the processor instructs the at least one actuating mechanism to independently actuate the first gripper assembly to engage the grabber device with the storage container and the second gripper assembly to engage the grabber device with the delivery container.

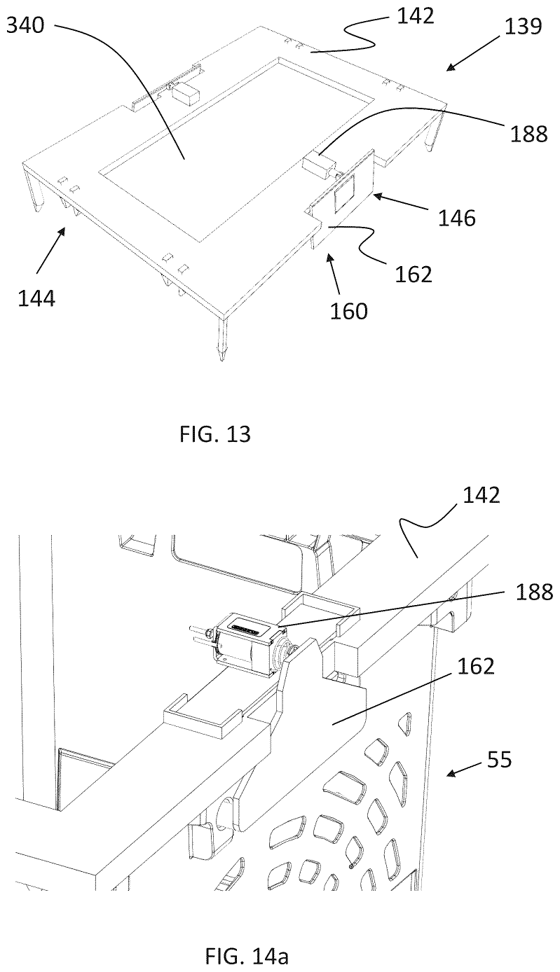

The at least one actuating mechanism undergoes a sequence of actuations to independently engage the grabber device with the storage container and the delivery container. The sequence of actuations of the at least one actuating mechanism depends on whether the grabber device is configured to separate the delivery container from the storage container or engaging the storage container and this can be exemplified by the flow chart shown in FIG. 12. In all cases, the sequence of actuations of the at least one actuating mechanism is instructed by a control system. The steps of separating the delivery container from the storage container (shown by the path A in FIG. 12) involves actuating the second gripper assembly 146 to engage the grabber device with the delivery container 166 and if the first gripper assembly is still engaged with the storage container 168, deactuating the first gripper assembly to release the grabber device from the storage container 170 such that when the grabber device is raised or hoisted by the drive mechanism, the delivery container separates from the storage container. In the case where the first gripper assembly is the pair of wings or legs, deactuation of the first gripper assembly involves collapsing the pair of wings or legs such that the pair of wings or legs can be extracted from the opening in the rim of the storage container. Similarly, the step of engaging the grabber device with the storage container (shown by the path B in FIG. 12) involves actuating the first gripper assembly to engage with the storage container 174 followed by deactuating the second gripper assembly from the delivery container 178. The additional step of deactuating the second gripper assembly from the delivery container to release the grabber device from the delivery container when hoisting the storage container can be optional 175 as it will not impact the ability of the container lifting mechanism, more specifically, it will not impact the drive mechanism hoisting the storage container 180. In the case where the second gripper assembly is the clamping mechanism, deactuating the clamping mechanism involves moving the pair of clamps outwardly to disengage from the delivery container sidewalls (see FIG. 10a). In all cases, the control system is configured to actuate the pair of legs of the first gripper assembly in synchronisation to engage or disengage with the storage container. Likewise, the control system is configured to actuate the pair of clamps or plurality of fingers of the second gripper assembly in synchronisation to engage or disengage with the delivery container.

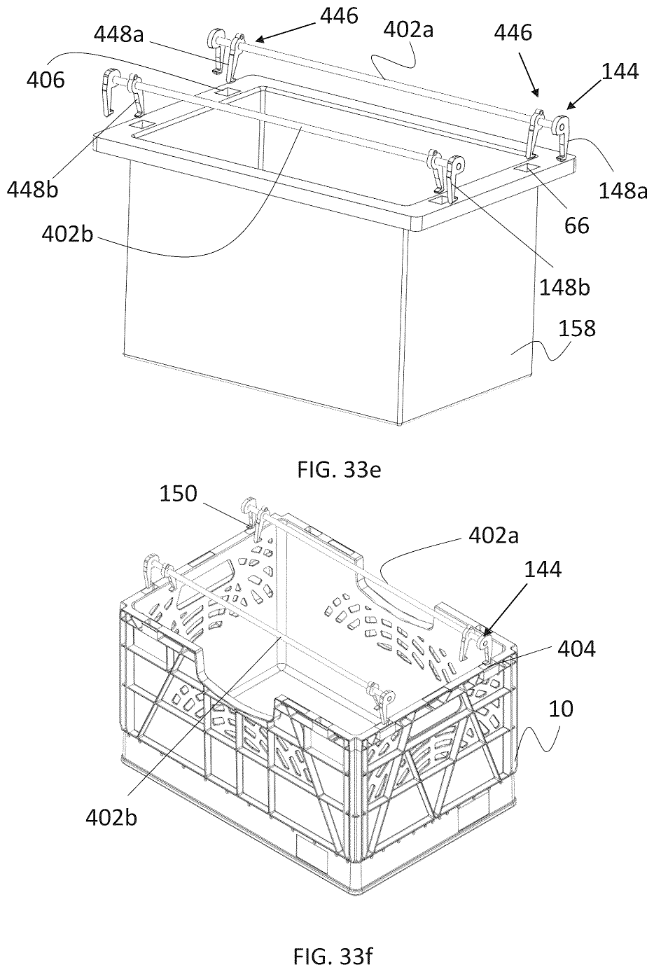

Each of the first and second gripper assemblies 144, 146 can be actuated by separate actuating mechanisms, namely a first actuating mechanism for actuating the first gripper assembly and a second actuating mechanism for actuating the second gripper assembly or alternatively, both the first and second gripper assemblies can be actuated by a single actuating mechanism. The number of actuating mechanisms to independently actuate the first gripper assembly and the second gripper assembly and thus, the number of actuating steps to combine and separate the storage container and the delivery container largely depends on whether the first gripper assembly is connected or coupled to the second gripper assembly. Where the first gripper assembly is coupled to the second gripper assembly, a single actuating mechanism can be used to actuate the first and second gripper assemblies to engage the grabber device with the storage container and the delivery container respectively. For example, the actuating mechanism can be configured to engage the first gripper assembly with the storage container in a first direction of movement of the first gripper assembly and to engage the second gripper assembly with the delivery container in a second direction of movement of the second gripper assembly. Since the first gripper assembly is coupled to the second gripper assembly, when the first gripper assembly is engaged with the storage container, the second gripper assembly releases the delivery container and when the second gripper assembly is engaged with the delivery container, the first gripper assembly releases the storage container. An example of such an arrangement of an actuating mechanism when the first gripper assembly is coupled to the second gripper assembly is discussed below with reference to FIG. 33(a to c).

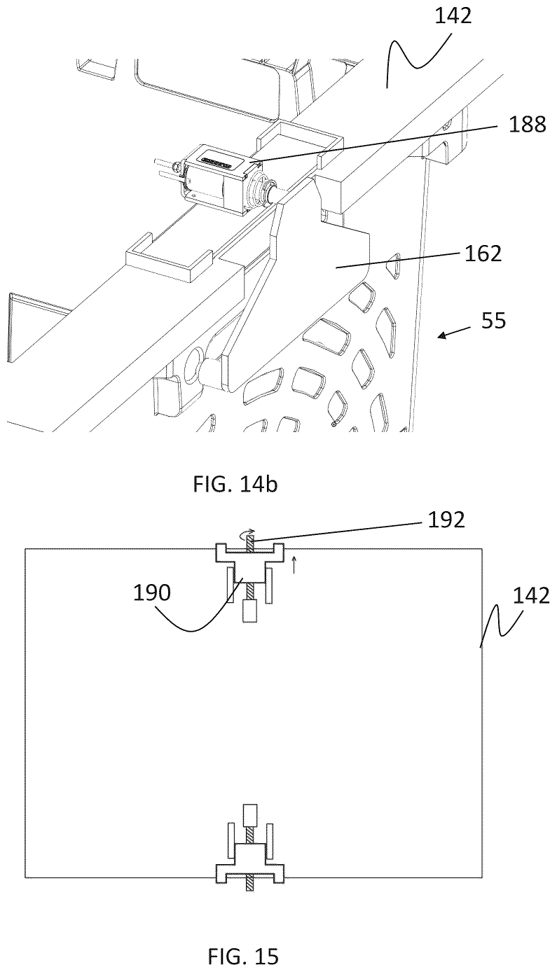

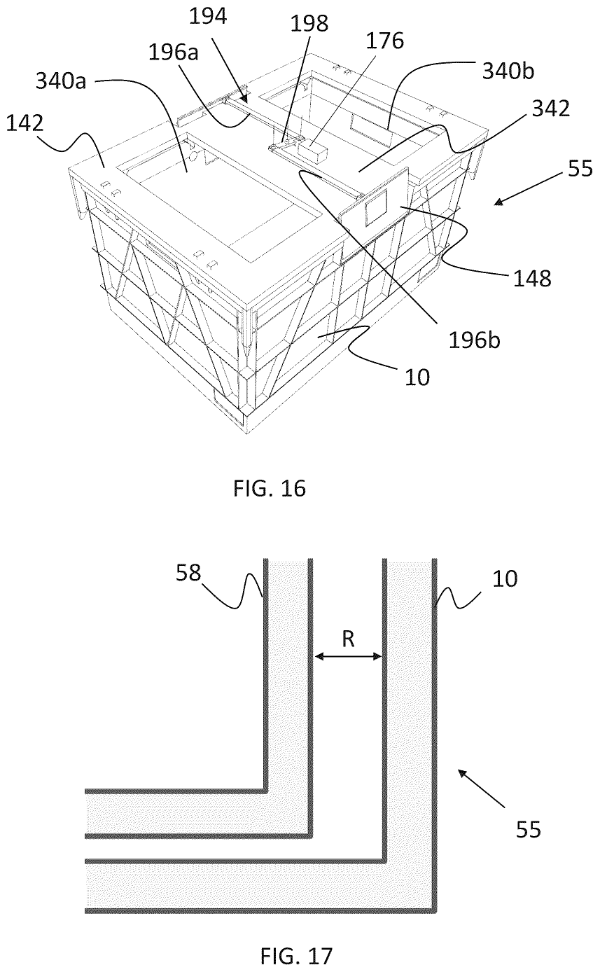

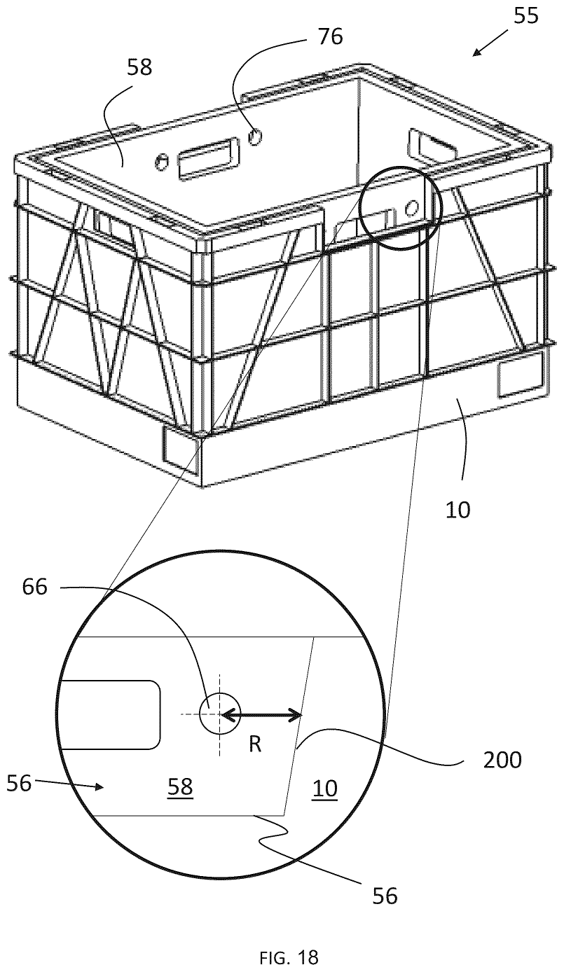

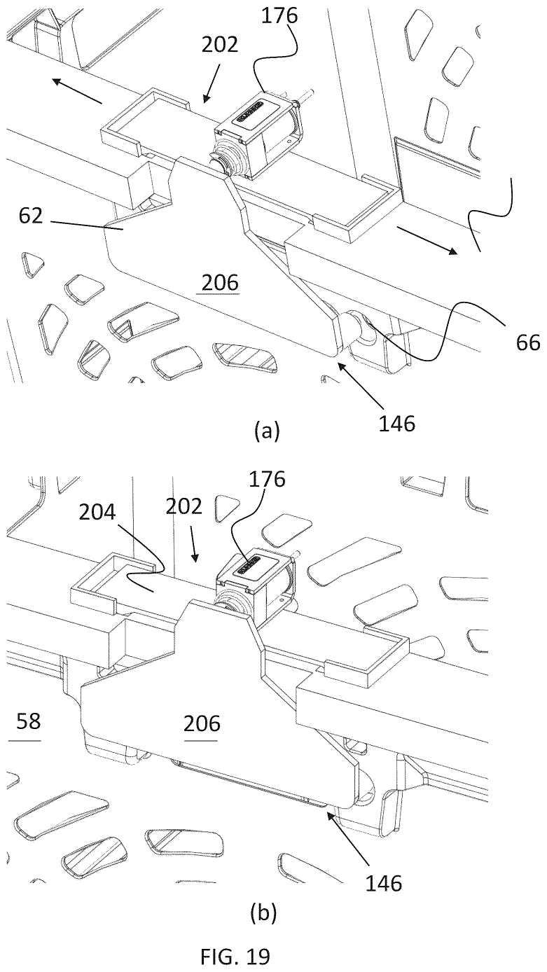

Different types of actuating mechanisms known in the art can be used to actuate the first and second gripper assemblies. For example, the at least one actuating mechanism can comprise a linear actuator 176 (see FIG. 16). In the case, where the second gripper assembly comprises the clamping mechanism, the at least one actuating mechanism can be configured to move the pair of clamps between the open configuration and the closed configuration. In the particular example shown in FIG. 11(a and b), the linear actuator can comprise a rack and pinion assembly 182 comprising a pinion engageable with first and second racks 186(a and b). The first and second racks 186(a and b) are respectively connected to the pair of clamps 148 such that rotation of the pinion 184 causes the first and second racks 186(a and b) to move in opposing linear directions, which in turn causes each of the pair of clamps connected to the first and second racks to move between the open configuration and the closed configuration as shown in FIG. 11(a and b). Actuation of the pair of clamps is not limited to the rack and pinion assembly shown in FIG. 11(a and b), and can be any type of actuating mechanism that is capable of moving the pair of clamps between the open configuration and the closed configuration. Examples of the different types of actuating mechanisms capable of moving the pair of clamps between the open configuration and the closed configuration are shown in FIGS. 13 to 16. For example, the at least one actuating mechanism can comprise a linear solenoid 188 providing a pushing and pulling force to move the pair of clamps between the open and closed configuration. In the particular example shown in FIG. 13, separate linear solenoids 188 are mounted to the lifting frame 142 and are configured to separately actuate each of the pair of clamps 162 simultaneously or together between the open configuration and the closed configuration. FIG. 14(a and b) shows one of the linear solenoids 188 in a retracted position and an extended position to move one of the pair of clamps between the open and closed configuration respectively. Another example of the linear actuators to move the pair of clamps between the open and closed configuration is shown in FIG. 15. Instead of the linear actuator comprising a linear solenoid to move the pair of clamps, the linear actuator can be based on a worm gear 190 comprising a worm screw 192 having at least one groove that meshes with a toothed wheel such that rotation of the toothed wheel causes linear movement of the worm screw. At least one of the pair clamps is connected to the worm screw such that linear movement of the worm screw from a retracted position to an extended position causes the at least one of the pair of clamps to move between the open configuration and the closed configuration. As with the linear solenoid, separate worm gears 190 are shown in FIG. 15 mounted to the lifting frame 142 and each is configured to separately move each of the pair of clamps simultaneously between the open and closed configurations. However, the present invention is not limited to having separate linear actuators for moving the pair of clamps between the open and closed configuration and can comprise a single linear actuator that is configured to simultaneously move the pair of clamps between the open and closed configurations as shown in FIG. 10(a and b). In addition to the example of the single actuator actuating the pair of clamps shown in FIGS. 10 and 11(a and b), the pair of clamps can be connected to the single linear actuator by a plurality of link rods 194 that are pivotally connected to cause the pair of clamps 162 to move between the open and closed configurations. In the particular example shown in FIG. 16, the plurality of link rods 194 comprises first and second link rods 196(a and b), each of the first and second link rods has a first end connected to a respective clamp of the pair of clamps and a second end pivotally connected to an intermediate link rod 198. The intermediate link rod 198 is connected to the linear actuator 176 such that movement of the linear actuator cause the intermediate link rod 198 to exert a pulling or pulling force on the pair of clamps via their respective first and second link rods 196(a and b) depending on whether the linear actuator is in an extended configuration or retracted configuration.

In the case, where the clamping device comprises the plurality of arms or fingers as shown in FIGS. 10c and 10d, the at least one actuation mechanism is configured to rotate the shafts in a clockwise or an anti-clockwise direction to engage the plurality of arms or fingers 264 with the sidewalls of the delivery container. For example, instead of a linear actuator for moving the clamps between the closed and open configuration, the at least one actuator can comprise a rotary actuator 177 to rotate the shafts carrying the plurality of arms (see FIG. 10d). Rotation of the shaft in the first rotational direction engages the finger with the sidewall of the delivery container and rotation of the shaft in the second rotational direction (the second rotational direction being different to the first rotational direction) disengages the finger from the sidewall of the delivery container.

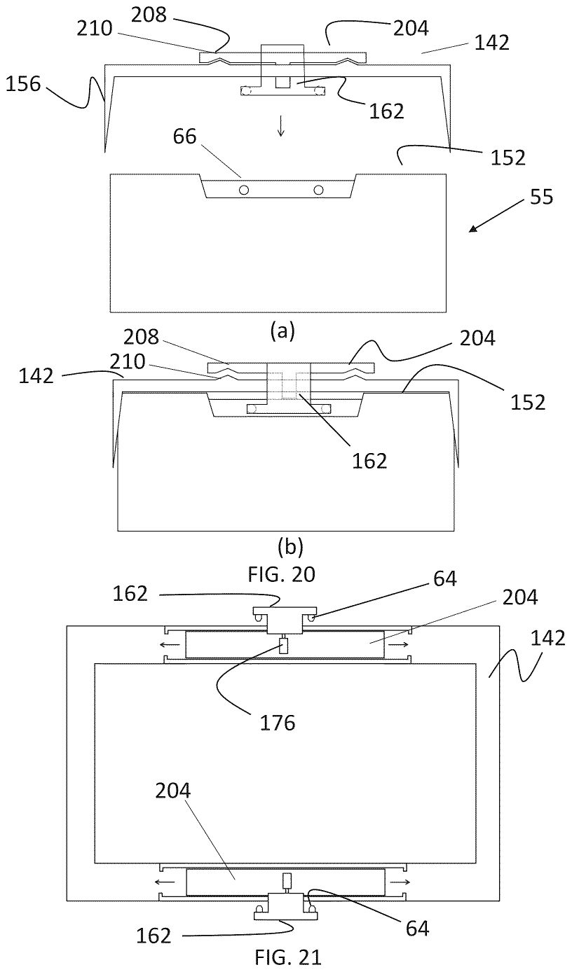

In order to facilitate the easy removal and insertion of the delivery container, the delivery container is sized to fit inside the storage with sufficient spacing between the exterior surface of the delivery container and the interior surface of the storage container. Without this spacing, there is the risk that the delivery container may get stuck in the storage container when attempts are made to separate the delivery container from the storage container. Typically, the exterior dimensions of the delivery container are such that a gap or spacing, R, exists between the exterior surface of the delivery container 58 and the interior surface of the storage container 10. This is exemplified by the schematic drawing of a cross-section of a corner section of a combined delivery container and storage container shown in FIG. 17. Typically, the value of R is in the range of 5 mm to 10 mm. However, the negative consequence of this spacing or gap between the exterior surface of the delivery container and the interior surface of the storage container is that the delivery container is susceptible to movement when nested within the storage container. In order for the engagement pins 64 of the clamping device 60 to be received in the openings 66 of the delivery container 58 when combined with the storage container, it is essential that the engagement pins 64 are correctly aligned with the corresponding openings 66 in the delivery container 58. While, the downwardly extending guide or locating pins 156 mounted to the lifting frame 142 position the grabber device or lifting frame relative to the storage container to enable proper engagement of the first gripper assemble 144 with the storage container, movement of the delivery container within the storage container may cause one or more of the openings 66 in the sidewalls of the delivery container to be misaligned with the engagement pins 164 resulting in failure of the pair of clamps to engage with the delivery container. Since the locating pins 156 prevent the lifting frame 142 from moving in a horizontal plane relative to the storage container, an alignment mechanism is necessary to separately align the second gripper assembly with the delivery container when the second gripper assembly is to engage with the delivery container.

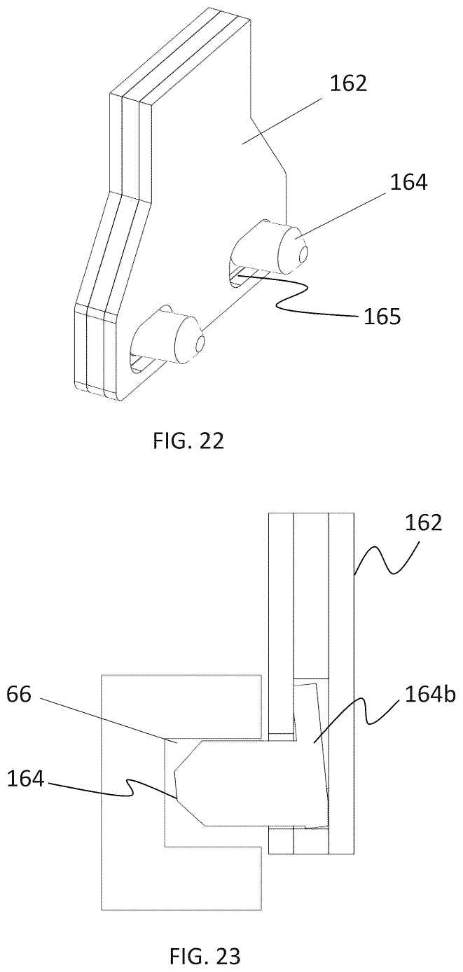

FIG. 18 schematically illustrates a merged storage container 10 and delivery container 58, showing the separation, R, of the engagement hole in the sidewall of the delivery container with reference to at least one edge 200 of the cut-out 56 in the storage container 10.

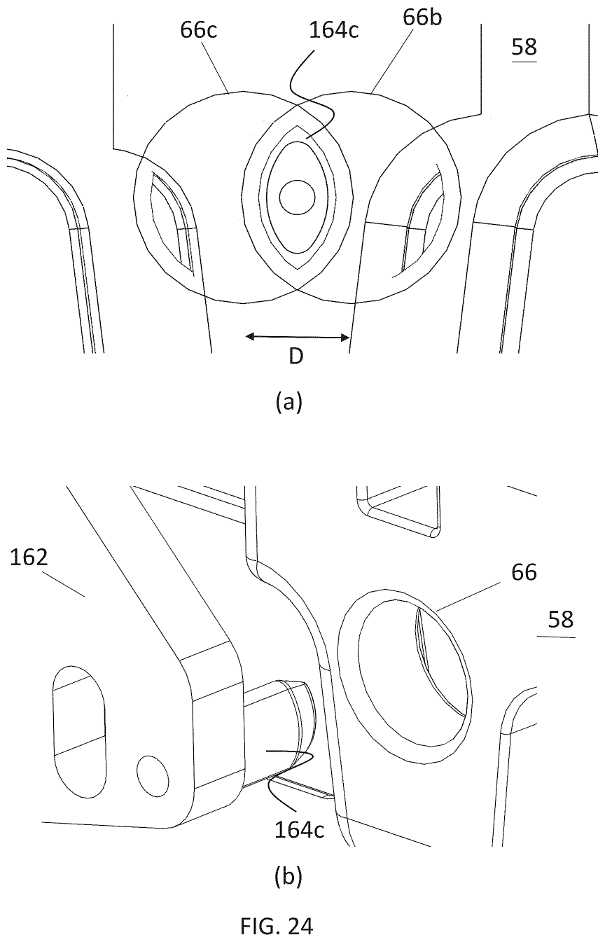

To correctly position the clamping device relative to the delivery container, the grabber device further comprises an alignment mechanism 202 that is configured to align the second gripper assembly with the engagement features of the delivery container, more specifically, the one or more holes or apertures 66 in the sidewalls of the delivery container. The alignment mechanism operates independently of the at least one actuating mechanism to align the second gripper assembly with the delivery container. There are numerous solutions according to the present invention to align the second gripper assembly with the engagement features of the delivery container. In all of the examples, the alignment mechanism is configured to cause the second gripper assembly to move relative to the delivery container, more specifically relative to the lifting frame in order to align the second gripper assembly with the delivery container. In one example of the present invention, the second gripper assembly self-aligns with the engagement features of the delivery containers when the second gripper assembly engages with the delivery container. In the particular example shown in FIGS. 19 to 21, the second gripper assembly 146 is moveably mounted to the lifting frame 142 and moveable in a longitudinal direction along one edge of the lifting frame 142, i.e., along a direction parallel to one of the edges of the lifting frame, such that the engagement pins correctly aligns with corresponding holes in the delivery container sidewalls.

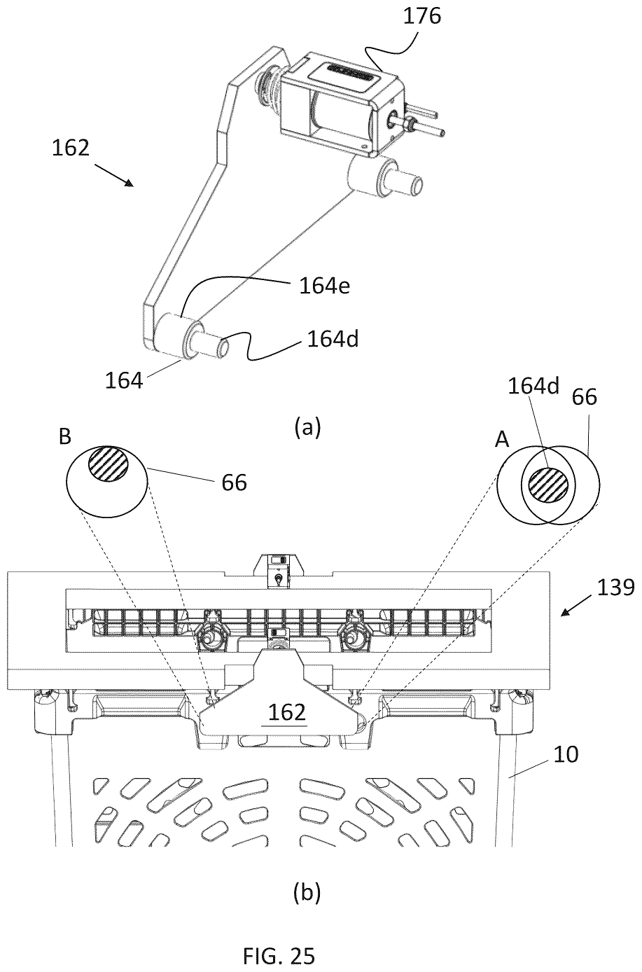

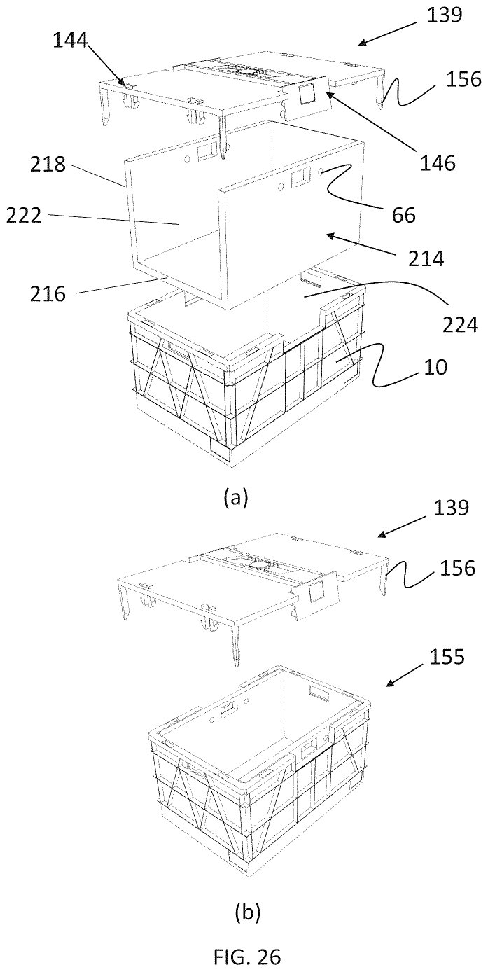

In one aspect of the present invention, the alignment mechanism is configured to cause each of the pair of clamps to move relative to the lifting frame when a clamping force is applied against the sidewalls of the delivery container. The leading ends of the engagement pins 164 are tapered so as to facilitate proper engagement of the clamping device with the sidewalls of the delivery container. As the tapered ends of the engagement pins 164 of the clamping device 60 are received in the openings 66 in the side walls of the delivery container 58 and if there is a misalignment between the clamping device and the openings in the sidewalls, the clamping force of the at least one actuator 176 (second actuating mechanism) will force the second gripper assembly 146 to move longitudinally relative to the lifting frame along a direction parallel to one of the edges of the lifting frame 142 (see FIG. 19(a and b), FIG. 20(a and b) and FIG. 21). To enable the second gripper assembly 146 to be moveable relative to the lifting frame along an edge of the lifting frame, the pair of clamps 162 are mechanically and moveably suspended from the lifting frame 142 (see FIG. 20(a and b). To be mechanically and moveably suspended from the lifting frame, each of the pair of clamps comprises an upper portion 204 for mounting the pair of clamps to the lifting frame and a lower portion 206 comprising the engagement pins 64. In the particular example shown in FIG. 19(a and b), the upper portion 204 is shown as a moveable plate. Each of the pair of clamps 162 is moveable between a lower position when the upper portion 204 of the pair of clamps 162 rests on the lifting frame 142 (see FIG. 20a) and an upper position when the upper portion 204 of the pair of clamps 162 disengages from the lifting frame 142 (see FIG. 20b). The lower position results when the pair of clamps is suspended from the lifting frame (see FIG. 20a)The upper position results when the lifting frame 142 rests or is seated on the rim 152 of the storage container or the delivery container resulting in the lower portion 206 of the pair of clamps butting up against the edge of the cut-out 56 of the storage container (see FIG. 20b).

The upper portion 204 of each of the pair of clamps comprises a plurality of teeth 208 that are engageable with corresponding teeth 210 of the lifting frame 142 such that when the pair of clamps 162 are suspended from the lifting frame 142, the upper portion 204 of the pair of clamps engages with the lifting frame 142 to lock the pair of clamps in a default position. The default position is generally centrally of a longitudinal edge of the lifting frame. As the grabber device is lowered onto the storage container, the lower portion of each of the pair of clamps is configured to butt up against the rim of the storage container, more specifically, the edge of the cut-out in the sidewalls of the storage container, causing the pair of clamps 162 to be lifted relative to the lifting frame 142. This in turn causes the upper portion 204 of each of the pair of clamps 162 to disengage from the lifting frame 142 permitting movement of the pair of clamps longitudinally along an edge of the lifting frame. The tapered ends of the engagement pins 64 and the clamping force of the at least one actuator 176 forces the pair of clamps to move longitudinally relative to the lifting frame 142 (see arrows on FIG. 21) along a direction parallel to one of the edges of the lifting frame. As the grabber device is hoisted by the drive mechanism, the lifting frame moves vertically relative to the pair of clamps until the upper portion of the pair of clamps, more specifically the plurality of teeth engage with corresponding teeth on the lifting frame resulting in the pair of clamps moving to its default position. The plurality of teeth 208 of the upper portion of a respective pair of clamps engages with the corresponding teeth 210 of the lifting frame 142 when in the default position and is therefore, prevented from moving longitudinally along the edge of the lifting frame (see FIG. 20a). Further raising of the grabber device, raises both the lifting frame and the pair of clamps and as the delivery container is connected to the pair of clamps, lifting of the delivery container. The locking mechanism prevents the delivery container connected to the grabber device from moving laterally or swinging side to side as it is hoisted by the drive mechanism of the container lifting mechanism. It will be appreciated that the pair of clamps or plurality of fingers of the second gripper assembly can cooperate with the lifting frame in a sliding arrangement to align their respective engagement pins with the one or more openings in the sidewall of the delivery container.

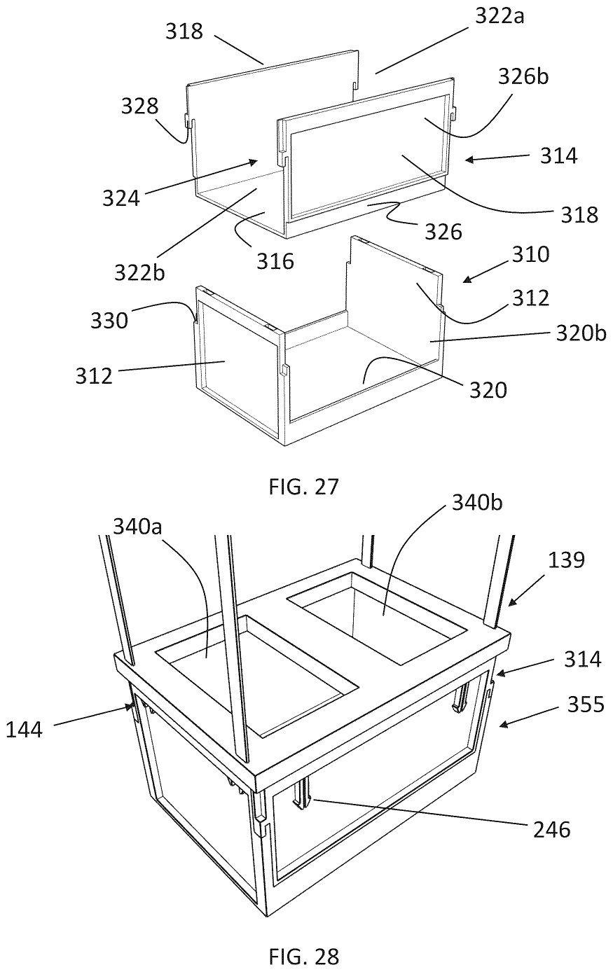

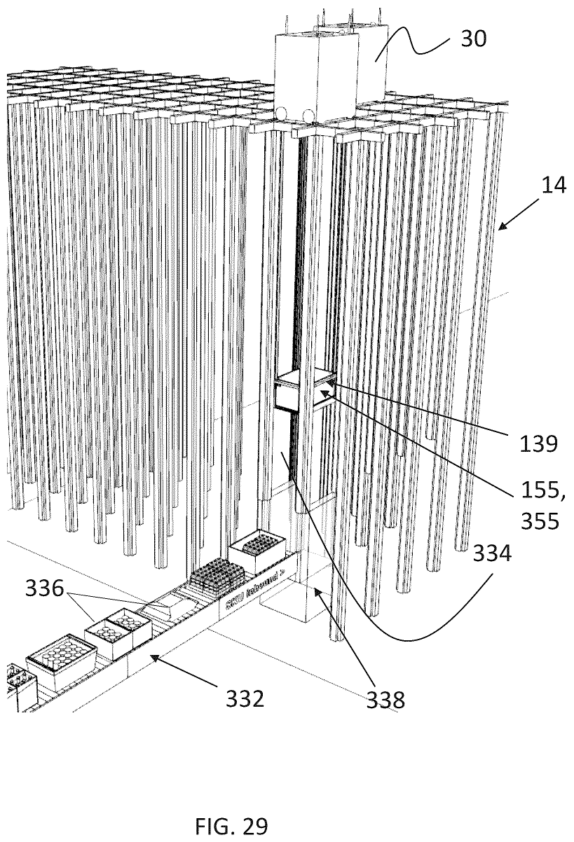

Alternatively or in addition to moving the pair of clamps relative to the lifting frame, the alignment mechanism can be configured such that the engagement pins 164 can move relative to their respective clamps 162 as shown in FIG. 22. In FIG. 22, the engagement pins 164 are slideably mounted to the clamps 162 by being moveable along respective slots 165 in the clamps 162. The tapered leading end of each of the engagement pins 164 facilitates movement of the engagement pins when a clamping force is applied to the clamping device. Each of the engagement pins comprises a back plate 164b that cooperates with an interior surface of a respective clamp to lock the engagement pins 164 in position when the engagement pins are received in the openings in the sidewalls of the delivery container (see FIG. 23).

In contrast to moving the clamps relative to the lifting frame or the engagement pins relative to their respective clamps in order to align the clamping device with the delivery container, the lifting frame itself can be configured to move the delivery container relative to the storage container. For example, the alignment mechanism 202 can be configured to engage with at least one exterior or interior wall of the delivery container 58 to position the delivery container 58 relative to the clamps 162. The alignment mechanism can comprise one or more guides 212 as taught in WO2023/062233 (Ocado Innovation Limited), the details of which are incorporated herein by reference, that are arranged to engage or interact with the delivery container so as to centre the delivery container within the storage container. For example, the alignment mechanism can comprise a plurality of downwardly extending locating pins or guides 212 that are configured to engage with diagonally opposed corners of the delivery container 58 when nested in the storage container (see FIG. 9). Four locating or guide pins 212 are configured to engage with the corners of the delivery container. When engaged with the delivery container 58, the locating pins 212 guide the delivery container centrally relative to the storage container and therefore, guide the delivery container into the correct position relative to the clamps of the clamping device 162. The one or more guide pins of the alignment mechanism are such that if the delivery container is off centre with respect to the storage container, the one or more guide pins interact with the walls of the delivery container and re-positions the delivery container within the storage container so as to enable the clamping device to clamp onto the delivery container nested within the storage container. To guide the delivery container into the correct position, at least a portion of each of the locating or guide pins 212 is wedge shaped or has an inclined guiding surface such that when engaged with the corners of the delivery container, the delivery container is moved into the correct position thereby, ensuring that the openings 66 in the at least one side wall of the delivery container is aligned with the engagement pins 164 of the clamps 162. However, the problem with physically moving the delivery container relative to the storage container is the force necessary to physically move the delivery container relative to the storage container. Considering that the delivery container can weigh up to 35 kg, this force can exceed the force generated by the grabber device via the locating pins or guides.

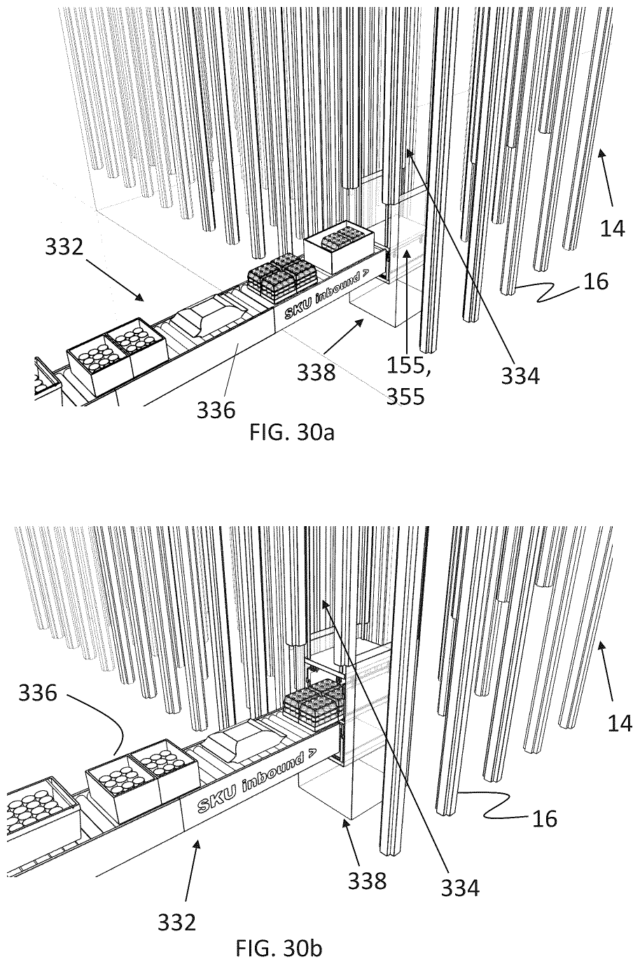

To mitigate the need to move the clamping device and/or the engagement pins into alignment with the openings in the side wall of the delivery container, in another embodiment of the present invention, the cross-sectional profile of the engagement pins can be shaped to form a sub-set of two intersecting circles that are laterally displaced. The two intersecting circles represent the lateral displacement of the openings 66 in the sidewall of the delivery container at two extremes as demonstrated in FIG. 24a. The mathematical shape of two intersecting circles is formally known as vesica piscis and represents the area that is shared by the two intersecting circles having the same radius. The cross-sectional profile of each of the engagement pins 164c has an oval shape or elliptical shape. By having an engagement pin with a cross-sectional profile that is shared between two intersecting circles displaced at the two extremes of movement of the delivery container greatly improves the chances of the engagement pin being received in the openings in the side walls of the delivery container. One of the circles 66b shown in FIG. 24a represents the lateral displacement of the delivery container towards one end within the storage container and the other circle 66c represents the lateral displacement of the delivery container towards the other, opposing end of the storage container. For example, with reference to FIG. 24a, the displacement, D, of the centre of each of the openings in the delivery sidewalls can range from 5 mm to 10 mm. By having an engagement pin 164c having a cross-sectional profile having the same shape as the area shared by the two intersecting circles increases the chances of the engagement pin being received in the openings 164c of the delivery container irrespective of the displacement of the delivery container within the storage container. An example of the engagement pin 164c having a cross-sectional profile that is shaped as a subset of two intersecting circles is shown in FIG. 24b.

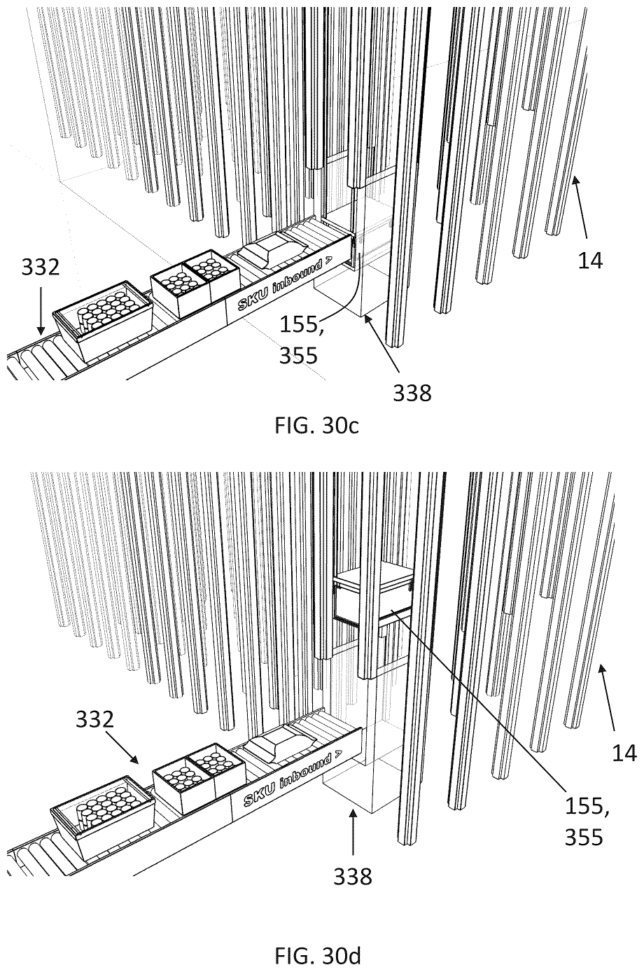

In another variant of the engagement pin shown in FIG. 25(a and b), the engagement pin 164 comprises a first portion or leading end 164d having a circular cross-sectional shape with a first diameter that is sized to be received in sub-set defined by two laterally displaced, intersecting circles (see point A in FIG. 25b) and a second portion 164e having a circular cross-sectional shape having a second diameter that is sized to be received in only one of the two intersecting circles. The diameter of the second portion 164e is greater than the diameter of the first portion 164d of the engagement pin to enable the engagement pin to be received in the opening in the sidewall of the delivery container. In this embodiment of the engagement pin 164, the first portion or leading end of the engagement pin 164d is configured to re-position the delivery container relative to the storage container so as to allow the second portion of the engagement pin to be aligned with the opening 66, also termed an engagement opening, in the sidewall of the delivery container (see FIG. 25b). The larger diameter of the second portion of the engagement pin 164e offers greater surface area contact with the engagement opening 66 when hoisting the delivery container. Due to the smaller cross-sectional diameter of the first portion or leading end of the engagement pin, the delivery container tries to “centre” itself on the engagement pin when the delivery container is suspended from the first portion of the engagement pin. In other words, the circular cross-section of the leading end of the engagement pin when received in the engagement hole 66 of the delivery container can be defined as two circles that touch internally where their point of contact lies on a straight line joining their centres (see point B in FIG. 25b). This allows the delivery container to centre itself on the first portion of the engagement pin when a downward force is applied on the engagement pin as a result of being suspended from the first portion of the engagement pin. To apply a downward force on the first portion of the engagement pin 164d, the delivery container is suspended from the first portion of the engagement pin when the delivery container is hoisted by the container lifting mechanism. Due to the smaller diameter of the first portion of the engagement pin 164d shared by two laterally displaced circles, the first portion of the engagement pin is easily received within the engagement hole of the delivery container when the clamping device clamps onto the sidewall of the delivery container, i.e. in the closed configuration of the clamping device (A of FIG. 25b). Once the delivery container is “centred” on the first portion of the engagement pin, the delivery container is lowered back into the storage container as shown in point B of FIG. 25b. The initial movement of the delivery container on the first portion of the engagement pin 164d centres the delivery container relative to the storage container. Subsequent to hoisting the delivery container on the first portion of the engagement, the delivery container is lowered back into the storage container resulting in the delivery container being re-positioned in the storage container. The process of hoisting the delivery container from the first portion of the engagement pin followed by lowering the delivery container back into the storage container aligns the engagement holes relative to the second portion of the engagement pins 164e such that when the clamping device clamps onto the sidewalls of the delivery container, the second portion of the engagement pins 164e can be received within the engagement holes 150. As the cross-section diameter of the second portion of the engagement pin 164e is much larger than the first portion, there is a greater surface contact area between the second portion of the engagement pin and the engagement hole in the sidewall of the delivery container resulting in the delivery container being more stable when being hoisted from the grabber device.

Each of the engagement pins of the clamping device have a cross-sectional profile that is shaped to be shared between two laterally displaced circles thereby removing the need for the clamps to be configured to move relative to the lifting frame in order for the engagement pins to align with the openings in the sidewalls of the delivery container. This in turn improves the simplicity of the alignment mechanism, i.e., removing the need for moving parts. It will be appreciated that the elliptical cross-sectional shaped profile of the engagement pin can be used in conjunction to the other forms of the alignment mechanisms discussed above to align the engagement pins with the openings in the sidewalls of the delivery container.

The alignment mechanism discussed above can also be adapted to move the plurality of arms or fingers longitudinally in a direction parallel to one of the edges of the lifting frame so as to align their respective engagement pins with the openings in the sidewalls of the delivery container. For example, the shafts carrying the plurality arms or fingers can be configured to move laterally in a direction along one of the edges of the lifting frame to cause the engagement pins to be aligned with the opening in the sidewall of the delivery container. Movement of the shafts can by the tapered cross-sectional shape of the leading end of the engagement pin discussed above or each of the engagement pins can comprise a first portion or leading end 164d having a circular cross-sectional shape with a first diameter that is sized to be received in sub-set defined by two laterally displaced, intersecting circles (see point A in FIG. 25b) and a second portion 164e having a circular cross-sectional shape having a second diameter that is sized to be received in only one of the two intersecting circles.

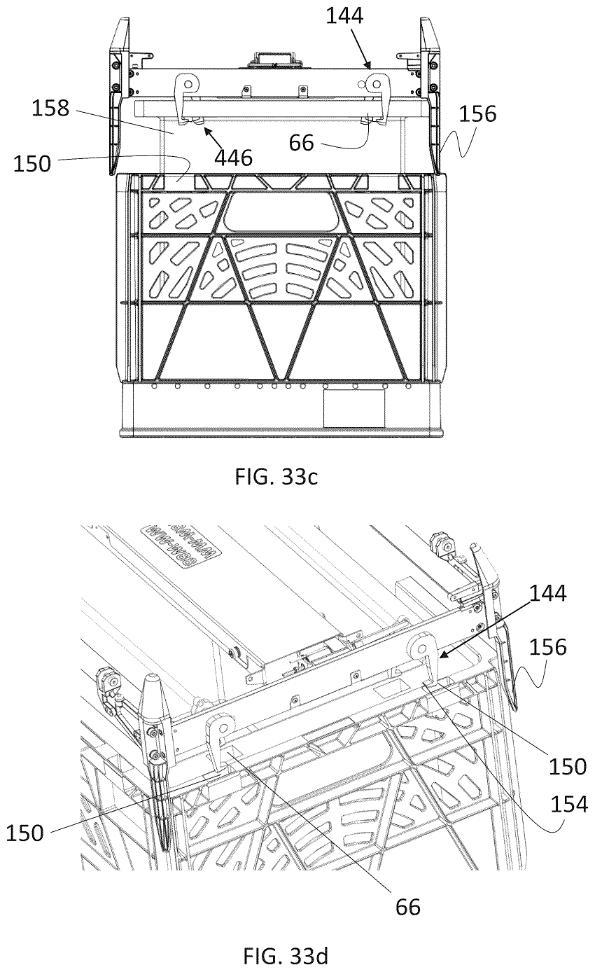

In another variant of the alignment mechanism shown in FIG. 32(a to f), the second gripper assembly 346 is moveably coupled to the lift frame 343 such that the second gripper assembly 346 floats relative to the lifting frame 343. In the particular example shown in FIG. 32(a to f), the second gripper assembly 346 is coupled to the lifting frame 343 by being mounted to a floating plate 348 as shown in 32(b), i.e., the alignment mechanism comprises a floating plate. Also shown in FIG. 32(a and b), is the lifting frame 343 being configured as a lifting plate. The lifting plate comprises a depression 350 to accommodate the floating plate 348. The floating plate 348 is moveably coupled to the lifting frame by one or more resilient members 352. In the particular example shown in FIG. 32(b), each of the one or more resilient members comprise a helical spring 352. Optionally, the floating plate 348 can be additionally coupled to the lifting frame 343 by one or more suspension connectors 354 such that the floating plate 348 is suspended from the lifting frame 343 by the one or more of the suspension connectors 354. The one or more suspension connectors 354 are moveably connected to the lifting frame 343 by being received in respective one or more slots (not shown) in the lifting frame 343. Examples of suspension connectors include but are not limited to mushroom head connectors. The one or more resilient members 352 are interposed between the opposing edges of the floating plate 348 and the lifting frame 343. The floating plate 348 is suspended from the lifting frame by the one or more suspension connectors, and is able to move and return to its original or default position relative to the lifting frame by virtue of the one or more resilient members.

As the second gripper assembly 346 is coupled to the floating plate 348, the second gripper assembly moves relative to the lifting frame when the floating plate moves relative to the lifting frame. The second gripper assembly is shown as a pair of clamps 148 as discussed above, each of the pair of clamps comprising one or more engagement pins 164. However, it will be appreciated that the second gripper assembly 346 can comprise one or more fingers as discussed above. Movement of the second gripper assembly and thus, the floating plate relative to the lifting frame can be by the tapered leading end of the engagement pins 164 being received in the one or more openings 66 in the sidewall of the delivery containers 58 as discussed above. In the particular example shown in FIG. 32(c and d), the grabber device 339 comprises a second set of locating features or locating pins 356 in addition to a first set of locating pins 156 used to align the first gripper assembly 144 with the storage container 10, to align the second gripper assembly 346 with the delivery container 58, more specifically, the engagement pins 164 with the one or more openings 66 in the sidewall of the delivery container 58. Thus, the grabber device 339 comprises the first set of locating features 156 for locating the first gripper assembly 144 into alignment with the storage container 10 and a second set of locating features 356 for locating the second gripper assembly 346 into alignment with the delivery container 58. The first set of locating features 156 is shown in FIG. 32(a) comprising the locating pins downwardly extending from the lifting frame 343 and coupled to the lifting plate 343. The first set of locating features 156 is configured to be received in the cut-outs at the corners at the storage container. As the lifting frame becomes immoveable in a lateral direction when the locating pins 156 are received in the corners of the storage container, the second gripper assembly 346 is guided into alignment with the delivery container 58 by virtue of the second set of locating features 356 cooperating with corresponding shaped depressions in the sidewall of the delivery container. The second set of locating features is shown in FIG. 32(b) downwardly extending from the floating plate 348 and coupled to the floating plate 348. Like the first set of locating features, the second set of locating features comprises tapered leading ends that cooperate with correspondingly shaped depressions 358 in the sidewall of the delivery container 58 to move the second gripper assembly 346 relative to the lifting frame 343. In the particular example shown in FIG. 32(c and d), the rim 360 of the delivery container 58 comprises one or more depressions 360 shaped to cooperate with the tapered leading ends of the second set of the locating features 356 to move the second gripper assembly relative to the lifting frame. Movement of the second gripper assembly can also be achieved by the tapered end of the engagement pins 164 being received in the one or more openings 66 in the sidewall of the delivery container as shown in FIG. 32d. However, the alignment mechanism to cause movement of the second gripper assembly to align with the delivery container can be by either the second set of locating features or the leading ends of the engagement pins or both.

In all cases, movement of the second gripper assembly 346 relative to the lifting frame 343 to align with the delivery container 58 is independent of the movement of the second gripper assembly 346 to engage with the delivery container 58 in the sense that the alignment mechanism causes the second gripper assembly 346 to move in a different direction relative to the lifting frame 343 to align with the delivery container 58. In the example of the present invention, the clamping force of the at least one actuating mechanism discussed above to engage with the delivery container can be used to cause the pair of clamps to move relative to the lifting frame to align with the delivery container by virtue of being mounted to the floating plate. In operation, the alignment mechanism is configured to cause the second gripper assembly to move in a first direction relative to the lifting frame to cause the one or more engagement pins 164 to be aligned with the one or more openings 66 in the sidewall of the delivery container 58. Subsequent to aligning the second gripper assembly, the at least one actuating mechanism causes the second gripper assembly 346 to move in a second direction relative to the lifting frame 343 to engage with the delivery container (see FIG. 32(f)). Typically, the first direction is different to the second direction. Typically, the first direction is substantially perpendicular to the second direction. The first direction is in a longitudinal direction along one of the edges of the delivery container and the second direction is along a clamping force substantially perpendicular to the first direction. The movement of the second gripper assembly relative to the lifting frame to align with the delivery container along the first direction is shown by the arrows along the axis X-X and the movement of the second gripper assembly relative to the lifting frame to engage with the delivery container along the second direction is shown by the arrows along the axis Y-Y in FIG. 32(d). In contrast to the first and second gripper assemblies being separately coupled to the lifting frame 449 as discussed above, in the example shown in FIG. 33(a to f) the first and second gripper assemblies 144, 446 can be coupled to each other such that movement of the first gripper assembly 144 controls movement of the second gripper assembly 446 and movement of the second gripper assembly 446 controls movement of the first gripper assembly 144. In other words, the first gripper assembly 144 is configured to engage with the storage container 10 in a first direction of movement the first gripper assembly 144 and the second gripper assembly 446 engages with the delivery container 10 in a second direction of movement of the second gripper assembly 446, wherein the first gripper assembly 144 controls the movement of the second gripper assembly 446 to engage or release the second gripper assembly 446 with the delivery container 158 and the second gripper assembly controls 446 the movement of the first gripper assembly 144 to engage or release the first gripper assembly 144 with the storage container 10. The first gripper assembly 144 releases the second gripper assembly 446 from the delivery container 158 when the first gripper assembly 144 engages with the storage container 10 in the first direction of movement of the first gripper assembly 144. Likewise, the second gripper assembly 446 releases the first gripper assembly 144 from the storage container 10 when the second gripper assembly 446 engages with the delivery container 158 in the second direction of movement of the second gripper assembly 446.

In the particular example shown in FIG. 33(e and f), the first and second gripper assemblies 144, 446 are mounted to at least one shaft 402a, 402b such that rotation of the at least one shaft 402a, 402b rotates both the first and second gripper assemblies 144, 446 at the same time to engage and release the storage container 10 and delivery container 158 respectively. As shown in FIG. 33(f), the first gripper assembly 144 comprises a first set of grippers 148a, 148b receivable in one or more openings 150 in the storage container 10 and the second gripper assembly 446 comprises a second set of grippers 448a, 448b receivable in one or more openings 66 in the delivery container 158. In the example shown in FIG. 33(e and f), the first set of grippers 148a comprises a first pair of gripper elements 148a mounted to a first shaft 402a and a second pair of gripper elements 148b mounted to a second shaft 402b such that rotation of the first shaft 402a rotates the first pair of gripper elements 148a and rotation of the second shaft 402b rotates the second pair of gripper elements 148b. Likewise, the second set of grippers comprises a first pair of gripper elements 448a mounted to the first shaft 402a and a second pair of gripper elements 448b mounted to the second shaft 402b such that rotation of the first shaft 402a rotates the first pair of gripper elements 448a and rotation of the second shaft 402b rotates the second pair of gripper elements 448b(see FIG. 33e). The first and second shafts 402a, 402b are rotated in synchronisation to engage and release the first and second sets of grippers with the storage container 10 and the delivery container 158 respectively. It will be appreciated that the number of shafts for carrying the gripper elements is not limited to two and can be any number of shafts or even a single shaft for rotating both the first and second sets of grippers to engage and release the storage container and the delivery container respectively.

In operation, rotation of the at least one shaft 402a, 402b in a first rotational direction engages the first set of grippers 148a, 148b with the storage container 10 and simultaneously moves the second set of grippers 448a, 448b to a disengaged ‘released’ position from the delivery container 158. Similarly, rotation of the least one shaft 402a, 402b in a second rotational direction releases the first set of grippers 148a, 148b from the storage container 10 and simultaneously moves the second set of grippers 448a, 448b to engage with the delivery container 158. In other words, rotation of the at least one shaft in the first or in the second rotational direction respectively releases and engages the storage container and delivery container simultaneously. To release and engage the storage container and the delivery container at the same time, the one or more openings 150 in the storage container is, optionally, offset from the one or more openings 66 in the delivery container 158 as shown in FIG. 33(d). To better explain the offsetting relationship of the one or more openings in the storage container and the delivery container, the one or more openings 150 of the storage container 10 comprises a first set of openings 404 in the sidewall of the storage container and the one or more openings 66 of the delivery container 158 comprises a second set of openings 406 in the sidewall of the delivery container. To engage and release the storage container and the delivery container at the same time, the first set of openings is offset from the second set of openings.

Each of the gripper elements of the first and second sets of grippers of the first and second gripper assemblies comprise fingers that are receivable in the corresponding openings of the storage container and the delivery container (see FIG. 33(c and d). To be receivable in the first and second sets of openings, the first and second sets of openings 404, 406 are located in the respective rims of the storage container 10 and delivery container 158 as shown in FIG. 33(e and f). The angle of rotation of the at least one shaft 402a, 402b controls the engagement and release of the first and second sets grippers with the storage container and the delivery container respectively. To enable the gripper elements of the first and second sets of grippers to be initially receivable in the openings of the storage container and the delivery container when the grabber device approaches the container unit (combined storage container and delivery container), the first and second sets grippers of the first and second gripper assemblies are mounted to the at least one shaft such that the first set of grippers are orientated in a first angular position and the second set of grippers are orientated in a second angular position (see FIG. 33c). Typically, the angle between the gripper elements of the first and second sets of grippers when at the first and second angular positions is an acute angle so as to enable the first and second sets of grippers to be receivable in the respective openings in the storage container and delivery container respectively.

The offsetting nature of the first and second sets of openings enables the corresponding fingers of the first and second gripper assemblies to be receivable in the openings of the storage container and the delivery container when the first and second sets of grippers are at the first and second orientation respectively. Rotating the at least one shaft in the first rotational direction such that the fingers are orientated in a third angular position engages the gripper elements of the first gripper assembly with the storage container and releases the gripper elements of the second gripper assembly from the delivery container. If the delivery container is nested in the storage container, the delivery container is lifted when the grabber device is raised. Rotation of the at least one shaft in the second rotational direction, rotate the gripper elements of the second gripper assembly to a fourth angular position and engages their corresponding gripper elements with the delivery container and releases the gripper elements of the first gripper assembly from the storage container. Thus, the angle of rotation of the at least one shaft controls whether the first gripper assembly grips the storage container or the second gripper assembly grips the delivery container. It will be appreciated that different angles of rotation and the direction of rotation of the at least one shaft controls the engagement of the first gripper assembly and the second gripper assembly with the storage container and the delivery container respectively. Each of the gripper elements of the first and second gripper assemblies comprises a stop or foot 154 that engages with corresponding openings in the storage container and delivery container when the at least one shaft rotates in the first rotational direction or the second rotational direction. The corresponding gripper elements and thus, feet of the first and second gripper assemblies are orientated in opposing directions to enable the first and second gripper assemblies to engage with the storage container and the delivery container when the at least one shaft is rotated in opposing rotational directions, i.e., clockwise and anti-clockwise directions.

An advantage of coupling the first gripper assembly to the second gripper assembly such that they move together when the at least one shaft rotates is the ability to operate without an alignment mechanism. Not only the offsetting nature of the one or more openings in the storage container and the delivery container controls whether the fingers of the first and second sets of grippers are received in their respective one or more openings when the lifting frame 442 is mounted on the container unit (combined storage container and delivery container), the size of the one or more openings in the storage container and the delivery container also controls whether the first and second sets of grippers are received in their respective openings. For example, the size of the first and second set of openings 404, 406 can be controlled to accommodate the first and second sets of grippers when the lifting frame is mounted on the container unit. In some embodiments, the size of the first set of openings 404 may be (preferably is) different than the size of the second set of openings 406 to accommodate the corresponding gripper elements of the first and second gripper assemblies when the lifting frame is mounted on the container unit. The different sizes of the first and second sets of openings and their offsetting nature enables the first gripper assembly to engage with the storage container in the first rotational direction of the at least one shaft and the second gripper assembly to engage with the delivery container in the second rotational direction of the shaft.

Another benefit of the present invention is the ability to transfer one or more items into and/or out of the storage containers removing the need to pick the items for transfer into the storage containers. Typically, items to be stored within the storage and retrieval system are stored within the storage containers. An item may be a product that is stored directly in a storage container. An item may also be a sub-container designed to fit within a storage container. The sub-container may contain products for storage, or assembled orders to be delivered to customers. Given the wide range of products that may be stored in the storage and retrieval system, automating the transfer of products into and out of storage containers is difficult and is typically carried out manually. Sub-containers are typically transferred into and out of storage containers at a decant station by hand, or by machines specifically configured to handle a specific design of sub-containers and storage container.

A benefit of having a grabber device that is configured to independently actuate the first gripper assembly to engage with a storage container and a second gripper assembly to engage with an insert nested within the storage container is that at least one of the plurality of storage columns can be configured as an inbound area for decanting one or more items into the storage containers. Instead of the insert being a delivery container discussed above comprising opposing sidewalls and end walls to form an enclosure with a top opening, at least one end wall or sidewall of the insert can be open to define an opening for allowing one or more items to enter the insert in a substantially horizontal direction.

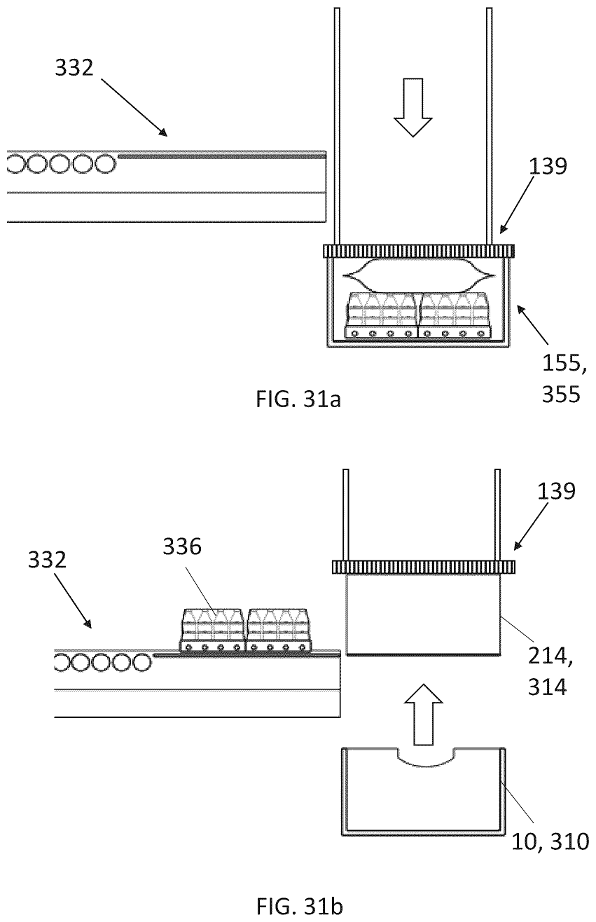

FIG. 26a shows the insert 214 in a position vertically above the storage container 10 and FIG. 26b shows the insert nested within the storage container to form the container unit 155. The insert 214 comprises a rectangular insert base 216 and two opposing insert sidewalls 218, one end wall 220 extending upwardly from the insert base 216 and the other end wall being absent to define an end opening 222. The insert base 216, sidewalls 218 and end wall 220 are substantially planar. The insert base 216 is sized in the width and length dimension so that the insert 214 can be inserted into the storage container 10 via the top opening 224 of the storage container 10. The insert sidewalls 218 preferably do not extend above the top of the storage container 10 so as to enable the grabber device 139 to releasably engage with the insert 214 and the storage container 10. The insert base 216 and sidewalls 218 may be substantially rigid and may be made of, for example, a metal material. The insert base 216 may be made from or coated in a material that provides a low-friction surface to allow items to slide relatively easily across the surface of the insert base 216. For example, the coefficient of friction of a particular item sliding on the low-friction surface of the insert base 216 may be lower than the coefficient of friction of that same item sliding on the storage container base. However, the insert 214 is not limited to at least one of the end walls being open. Both opposing end walls can be open to form a U-shaped insert 314 that defines a horizontally extending insert channel 324 having two opposing end openings 322a, 322b that defines a horizontal longitudinal axis running through the end openings 322a, 322b. The advantage of having opposing end openings is the ability to load and/or unload one or more items onto and off the insert base from the opposing end openings without the need to rotate the insert.

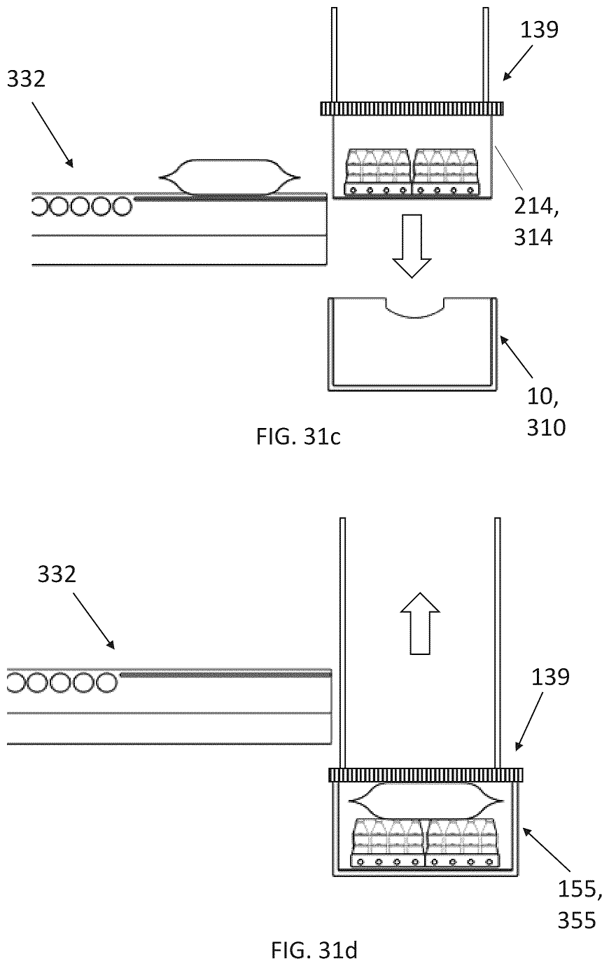

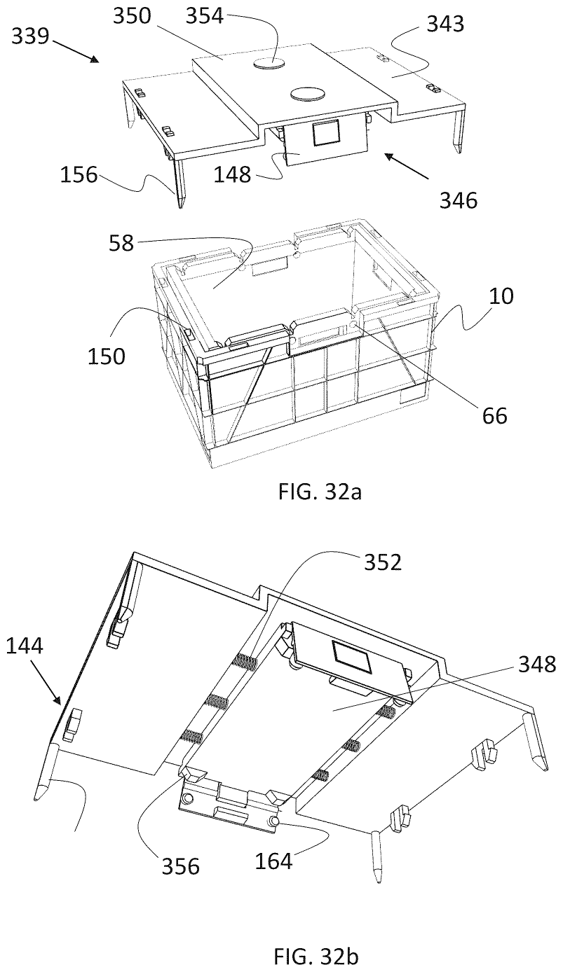

In another variation of the insert 314, the insert sidewalls 318 can be contiguous with the storage container sidewalls to define the external sidewalls of the container unit 355, i.e. combined storage container and insert. In the particular example of the storage container 310 shown in FIGS. 27 and 28, the two opposing container end walls 312 are taller than the two opposing container sidewalls 320 to define two opposing container side openings 320b. The insert base 316 and a lower portion 326 of the insert sidewalls 318 are sized and configured to nest within the storage container 310. However, an upper portion 326b of each insert sidewall 318 extends horizontally outwards with respect to the lower portion 326 such that each upper portion 326b occupies a respective side opening 320b when the insert 314 is nested within the storage container 310. In this way, the insert sidewalls 318 and the container sidewalls 320 form a contiguous structure (i.e. forming the external sidewalls of the container unit 355) when the insert 314 is nested within the storage container 310. One of the advantages of this variation is that the overall container unit 355 can be made lighter and cheaper compared to the container unit 55 described above in relation to FIG. 8c because the storage container 310 comprises less material. The base 316 of the insert 314 is still nested within the storage container 310 in this variation which helps to prevent the insert 314 from sliding out of or away from the storage container 310 in a horizontal direction. To help further prevent unwanted relative movement between the insert 314 and the storage container 310 and to stabilise the structure of the container unit 355, the insert sidewalls 318 can be configured to interlock the taller container sidewalls in a vertical direction, at the vertical edges (between the corners) of the container unit 355. In the example shown in FIG. 27, each vertical edge of the insert sidewalls 318 comprises a downwardly extending protrusion 328 which is received into a corresponding recess or cut-out 330 in a respective vertical edge of the taller container sidewalls such that the insert sidewalls 318 and the container sidewalls interlock at the vertical edges of the container unit 355.

In all of the examples of the insert, the second gripper assembly is adapted to engage with the insert so that the drive mechanism of the container lifting mechanism can vertically move the insert out of the storage container to a raised position at which the insert base is above the storage container and vertically move the insert back into the storage container from the raised position. In the particular examples of the insert shown in FIGS. 26a-b, the same type of the second gripper assembly 146 comprising the clamping mechanism can be used to vertically move the insert to the raised position. Like the delivery container discussed above, the opposing sidewalls of the insert can comprise one or more openings or apertures 66 to enable engagement with the grabber device. Alternatively and like the engagement features of the first gripper assembly 144, the upper portion of each insert sidewall can comprise openings or apertures that are sized to receive the gripper elements, e.g. legs or wings, of the second gripper assembly 246 (see FIG. 28). Equally, the grabber device further can comprise an alignment mechanism discussed above that is configured to align the second gripper assembly with the engagement features of the insert. However, the engagement features of the insert is not limited to the engagement features shown in FIGS. 26a-b, 27, and 28 and can by any type of engagement feature enable the insert to be moved vertically out of the storage container by engagement with the grabber device.

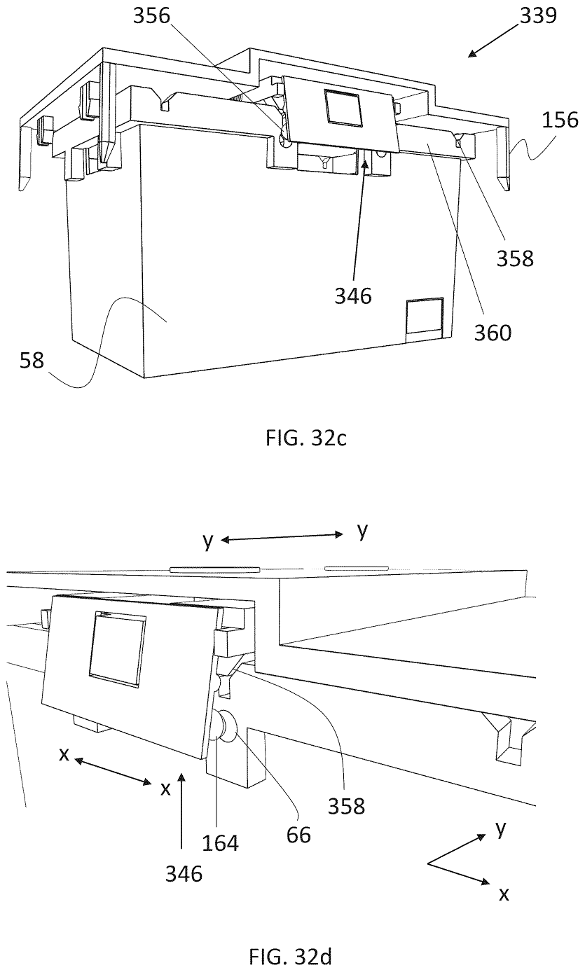

By raising the insert out of the storage container to the raised position, one or more items can be moved horizontally onto the insert base via the end opening. Because items can be transferred into the insert 214, 314 by lifting the insert 214, 314 and moving items in only a horizontal direction, there is no need to transfer items by picking them up, and therefore there is no need to take into account how different types of items (which may have different shapes, sizes, weights, fragilities etc.) need to be gripped and lifted in an automated system. There is therefore also no need to provide specialist equipment for picking each different type of item. To move the one or more items horizontally onto the insert base when the insert is in the raised position, the present invention further provides an item moving device 332 associated with at least one of the plurality of storage column of the grid framework structure to define an ingress column 334 of the grid framework structure 14 (see FIG. 29). The combination of the specially adapted grabber device enables a load handling device operable on the track system to decant one or more items into storage in one or more storage containers in the grid framework structure.

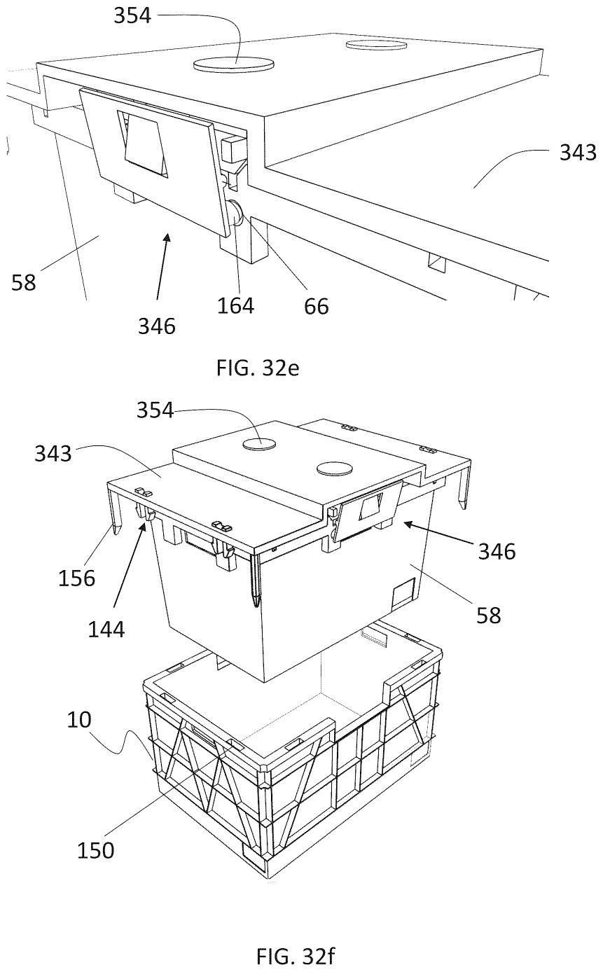

As shown in FIGS. 30a-d, the ingress column 334 is accessible externally of the grid framework structure 14. The ingress column 334 is adapted so that one or more items 336 can be pushed onto the insert base 216, 316 when the insert 214, 314 is in the raised position. The spacing between the upright members 16 in a given storage column allows one or more items 336 to be conveyed between the upright members 16 externally of the grid framework structure. Additionally, the ingress column 334 comprises a transfer station 338 for receiving a container unit (combined storage container and insert) lowered by a grabber device of a load handling device operable on the track system and enable the grabber device to vertically move the insert out of the storage container to the raised position for receiving the one or more items, and to lower the insert back into the storage container for storage into the grid framework structure. In the particular example of the present invention, the transfer station comprises a lower portion that is adapted to receive a container unit 155, 355 when lowered by the load handling device operable on the track system and an upper portion for vertically moving the insert into the raised position.

The transfer station 338 is associated with the item moving device 332 that is configured to apply a horizontal force to move the item in a horizontal direction onto the insert base when the insert is in the raised position. In the particular example of the present invention, the item moving device 332 comprises an inbound item conveyor configured to apply a pushing force to push one or more items from the inbound item conveyor onto the insert base when the insert is in the raised position. The transfer station comprises an entrance adjacent the inbound item conveyor such that one or more items on the inbound item conveyor is moved horizontally onto the insert base via the entrance of the transfer station. The inbound item conveyor may be mounted on a platform or a frame or any other suitable mounting surface.

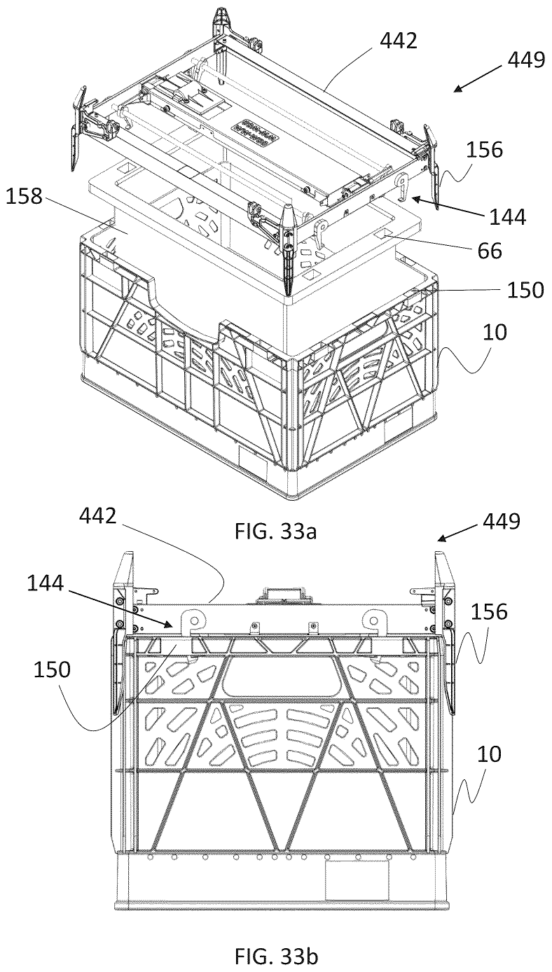

The procedure for decanting one or more items into the container unit via the ingress column 334 is described below with reference to FIG. 30a-d in conjunction to FIGS. 31a-d. FIGS. 30a-d show the transfer of one or more items into the storage containers in the grid framework structure and FIGS. 31a-d are schematic drawings showing the relationship between the container unit and an item transfer unit when transferring one or more items into the storage container. Control of the load handling device on the track system to retrieve one or more container units can be by the control system discussed above and the operation of the container lifting mechanism can be by the same control system to control the actuation the first gripper assembly and the second gripper assembly or a separate control system internal of the load handling device. In use, when decanting or restocking one or more items into the grid framework structure, a load handling device operable on the grid framework structure retrieves an empty or partially empty container unit 155, 355 (combined storage container and insert) from a storage column by instructing the grabber device to engage with the storage container via the first gripper assembly and transporting the container unit to the ingress column 334. Once at the ingress column, the load handling device is instructed to lower the container unit 155, 355 into the transfer station 338 (see FIGS. 30a and 31a).

The transfer station 338 extends from a lower position above below the item moving device 332 to an upper position above or at the same level of the item moving device 332. When the container unit is engaged with the grabber device via the first gripper assembly, the drive mechanism of the container lifting mechanism is instructed to lower the container unit to the lowered position as shown in FIGS. 30a and 31a. Once at the lowered position, the grabber device 139 is instructed to disengage from the storage container by de-actuating the first gripper assembly and to engage with the insert by actuating the second gripper assembly. Actuation of the grabber device with the insert follows the same path ‘A’ shown in the flowchart in FIG. 12.

The drive mechanism of the container lifting mechanism is controlled to lift the insert to the raised position such that the insert base is substantially level with the inbound item conveyor 332 as shown in FIGS. 30b and 31b. At this position, the inbound item conveyor 332 is adjacent to the insert base through the entrance of the transfer station such that the inbound item conveyor 332 can push one or more items onto the insert base as shown in FIG. 30b. Having at least one end opening of the insert exposed to the entrance of the transfer station 338 enables one or more items to be moved along a substantially horizontal direction from the inbound item conveyor 338 onto the insert base. To facilitate movement of the one or more items 336 onto the insert base, the insert base may be made from or coated in a material that provides a low-friction surface to allow items to slide relatively easily across the surface of the insert base. For example, the coefficient of friction of a particular item sliding on the low-friction surface of the insert base may be lower than the coefficient of friction of that same item sliding on the storage container base. Optionally, the item moving device 332 may comprise a pushing member in the form of a vertically orientated pushing plate (not shown) with a pushing surface orientated perpendicular to the longitudinal axis of the insert channel. The pushing plate is linearly movable (e.g. using a linear actuator) in a horizontal direction parallel to the longitudinal axis of the insert channel. The pushing plate is located at substantially the same level as the raised position of the insert, adjacent to the end opening of the insert channel.

Once the items have been transferred from the inbound item conveyor 332 onto the insert base, the insert is lowered back into the storage container by the drive mechanism until the insert is nested back inside the storage container defining the container unit 155, 355 as shown in FIGS. 30c and 31c. At the lowered position, actuation of the grabber device follows the same path B shown in the flowchart in FIG. 12. The grabber device is instructed to engage with the storage container by actuating the first gripper assembly 144. De-actuation of the second gripper assembly 146 from the grabber device is optional as the raising of the container unit is not necessarily dependent on whether the second gripper assembly is actuated or not. Once actuated to the storage container, the combined storage container and insert (container unit) can be lifted above the track system into the container receiving space of the load handling device for storage in a storage column of the grid framework structure (see FIGS. 30d and 31d). While the particular embodiment of the present invention shown in FIGS. 30a-d and 31a-d shows the one or more items being decanted into the storage container via at least one end opening of the insert, the present invention is not limited to the insert having an end opening and the insert can have a side opening such that one or more items can be transferred onto the insert base via the side of the insert.

In comparison to physically picking items for decant into the storage containers, the present invention allows for an automated, flexible, multi-functional item transfer system simply by moving the items along a substantial horizontal direction into the storage container. Moreover, the one or more items decanted into the container units via the transfer station can correspond to items for fulfilling one or more customer orders which are stored into the grid framework structure until a scheduled time when the insert is ready for dispatch at the dispatch facility or delivered to the dispatch facility.

In addition to decanting one or more items into the storage containers for storage in the grid framework structure, the transfer station can be configured to transfer one or more items out of the storage containers. The item moving device associated with the raised position of the insert can be configured to move the one or more items and/or the insert away from the transfer station. For example, the item moving device may be defined as an outbound item conveyor and configured to horizontally move an item off the insert base via the end opening when the insert is in the raised position such that the item is received on the outbound item conveyor. The outbound item conveyor may comprise a conveying surface on which items are transported. The conveying surface of the outbound item conveyor may be located at substantially the same height as the insert base, or lower than the insert base when the insert is in the raised position. The outbound item conveyor may be configured to receive items at a location adjacent one of the end openings of the insert.

Optionally, the item moving device may be a robotic arm, e.g. a Cartesian robotic arm or an articulated robotic arm. The robotic arm may be configured to horizontally push or pull an item onto or off the insert base via the end opening. While not shown in FIGS. 30a-d and FIGS. 31a-d, the one or more items may be loaded onto and/or removed from the inbound item conveyor or outbound item conveyor respectively, by a robotic arm. For example, the robotic arm may be configured to move items on pallets onto the inbound item conveyor for storage in the grid framework structure via the transfer station discussed above.

When gripping with the container unit, a situation can occur where the first and/or second gripper assemblies is obstructed from properly aligning and engaging with the top of container unit in a stack. This could be as a result of any items in the insert protruding above the top of the storage container and could lead to the grabber device failing to grip either the storage container or the insert. This in turn could lead to the grabber device insecurely gripping only a portion of the top of either the storage container or insert. In another optional aspect of the present invention, the lifting frame 142 having a top side and a bottom side can comprise a substantially downwardly extending peripheral wall defining at least one opening 340 through the top side and bottom side of the lifting frame (see FIG. 10). The lifting frame 142 can comprise four elongated frame members joined together to form a substantially rectangular frame having a substantially downwardly extending peripheral wall defining a substantially rectangular opening or cut-out in the centre 340. The opening extends completely through the top and bottom sides of the frame.

The opening 340 through the lifting frame provides headroom for any objects protruding above the top of the container unit when the grabber device 139 is being lowered towards the top of the container unit. In particular, when the grabber device 139 is being lowered towards the top of the container unit, any items protruding above the top of either the storage container or the insert are likely to protrude through the opening 340 without obstructing the descent of the grabber device 139, rather than hitting a portion of the lifting frame 142 and obstructing its descent.

The shape of the opening 340 may be the same shape as the lifting frame, i.e. rectangular. The shape of the opening 340 is not limited to being rectangular and may have other shapes, e.g. circular, triangular, other quadrilaterals, or other polygons. The lifting frame can optionally comprise a bridge member 342 extending across the lifting frame 142 between two ends of the lifting frame 142 (i.e. extending across the opening 340 between two opposing sides of the peripheral wall), thereby dividing the opening 340 into two smaller openings 340a, 340b on either side of the bridge member 342 (see FIG. 16). However, the lifting frame 142 may still be considered to have a single opening 340 that is partially occupied by the bridge member 342. The bridge member 342 preferably extends centrally across the lifting frame 142 so that the lifting frame 142 has an even weight distribution, which allows the lifting frame 142 to be maintained in a horizontal orientation more easily when raised or lowered, which may simplify the control and/or configuration of the container lifting mechanism 39. However, the bridge member 342 is not limited to extending centrally across the lifting frame 340 and instead may be positioned closer to one lateral side of the lifting frame 340 than another.

The bridge member 342 may conveniently be used for routing or mounting electrical and/or electronic components for operating the grabber device 139. The electrical and/or electronic components may be mounted on an outer surface of the bridge member 342 or the electrical and/or electronic components may be mounted inside the bridge member 342 (i.e. the bridge member 342 may be hollow). While the preferred embodiments of the present invention have been described in detail above, it should be understood that various modifications of the grabber device encompassing different features described above, and different combinations of features described in relation to different embodiments, are applicable within the scope of the present invention as defined in the claims.

In all of the different examples discussed above, the grabber device can further comprise one or more proximity sensors (e.g., infrared sensors or reflective sensors) for sensing when the grabber device is approaching or is in contact with the rim of the storage container and/or the delivery container. The one or more sensors can be mounted to the lifting frame carrying the first and second gripper assemblies. The one or more sensors can comprise a first sensor for sensing the presence of the rim of the storage container and a second sensor for sensing the presence of the rim of the delivery container. The control system in response to one or more signal from the first sensor actuate movement of the first gripper assembly to engage with the storage container. Similarly, the control system in response to one or more signals from the second sensor actuate movement of the second gripper assembly to engage with the delivery container. The control system can be instructed to actuate the first gripper assembly or the second gripper assembly in response to the one or more sensors detecting a predetermined proximity, e.g., predetermined height, from the rim of the storage container or the delivery container.

It will be appreciated that the process of combining and separating the delivery container and the storage container is discussed above is not limited to being on a load handling device, the container lifting mechanism can be formed as an end effector for a robotic arm. In this case, the drive mechanism for lifting and lowering the delivery container vertically in and out of the storage container is provided by the drive mechanism of the robotic arm.

What is claimed is:

1. A container lifting mechanism for combining and/or separating an insert and a storage container, the insert comprising an insert base and opposing insert sidewalls extending upwardly from the insert base, the insert being configured to nest within the storage container to define a container unit, the container lifting mechanism comprising:
a grabber device comprising a first gripper assembly configured to releasably engage the storage container and a second gripper assembly configured to releasably engage the insert nested within the storage container;
at least one actuating mechanism configured to actuate the second gripper assembly separately of the first gripper assembly to engage the insert nested within the storage container; and
a drive mechanism configured to raise and lower the grabber device to vertically move the insert out of the storage container to a raised position at which the insert base is above the storage container and to a lowered position at which the insert is nested within the storage container when the second gripper assembly is engaged with the insert.

2. The container lifting mechanism of claim 1, wherein the second gripper assembly is configured to engage externally of the insert.

3. The container lifting mechanism of claim 1, wherein the at least one actuating mechanism comprises a first actuating mechanism configured to actuate the first gripper assembly to engage the grabber device with the storage container and a second actuating mechanism configured to actuate the second gripper assembly to engage the grabber device with the insert.

4. The container lifting mechanism of claim 1, further comprising a control system configured to actuate the second actuating mechanism independently of the first actuating mechanism to engage the grabber device with the insert; and the first actuating mechanism independently of the second actuating mechanism to engage the grabber device with the storage container.

5. The container lifting mechanism of claim 4, wherein the control system is further configured to de-actuate the first actuating mechanism independently of the second actuating mechanism to disengage the grabber device from the storage container; and the second actuating mechanism independently of the first actuating mechanism to disengage the grabber device from the insert.

6. The container lifting mechanism of claim 1, wherein the grabber device comprises a lifting frame, and wherein the first and second gripper assemblies are moveably mounted to the lifting frame.

7. The container lifting mechanism of claim 1, further comprising an alignment mechanism configured to align the second gripper assembly relative to the insert, the alignment mechanism operates independently of the at least one actuating mechanism to cause the second gripper assembly move relative to the first gripper assembly.

8. The container lifting mechanism of claim 7, wherein the alignment mechanism comprises a first set of locating features for guiding the first gripper assembly into alignment with the storage container and a second set of locating features for guiding the second gripper assembly into alignment with the insert.

9. The container lifting mechanism of claim 7, wherein the alignment mechanism is configured to move a second gripper assembly relative to the lifting frame along a first direction and the at least one actuating mechanism is configured to move the second gripper assembly along a second direction to engage with the insert, wherein the first direction is different to the second direction.

10. The container lifting mechanism of claim 1, wherein the second gripper assembly comprises a clamping mechanism configured to clamp the insert side walls of the insert nested within the storage container.

11. The container lifting mechanism of claim 10, wherein the clamping mechanism comprises one or more engagement pins receivable in one or more apertures in the insert sidewalls when in the engagement position.

12. The container lifting mechanism of claim 10, wherein the clamping mechanism comprises a pair of clamps moveable between an engagement position to engage with the insert sidewalls and a disengagement position to disengage from the insert sidewalls.

13. The container lifting mechanism of claim 12, wherein the one or more of the engagement pins of each clamp of the pair of clamps is configured to move relative to their respective clamp.

14. The container lifting mechanism of claim 10, wherein the one or more engagement pins of each clamp of the pair of clamps has a cross-sectional shape defined by the intersection of two laterally displaced circles.

15. The container lifting mechanism of claim 1, wherein the first gripper assembly is coupled to the second gripper assembly such that movement of the first gripper assembly controls movement of the second gripper assembly and movement of the second gripper assembly controls the movement of the first gripper assembly.

16. A robotic load handling device for lifting and moving one or more storage containers stackable in a storage and retrieval system, the storage and retrieval system comprising a grid framework structure comprising a plurality of storage columns for the storage of a plurality of stacks of storage containers and a track system comprising a plurality of tracks arranged in a grid pattern comprising a plurality of grid cells, the track system being arranged above the plurality of storage columns for guiding the robotic load handling device on the grid framework structure, the plurality of the tracks being arranged such that each of the plurality of storage columns is below a grid cell; the load handling device comprising:
(a) a wheel assembly comprising a first set of wheels for moving the load handling device on the track system in a first direction and a second set of wheels for moving the load handling device on the track system in a second direction, wherein the second direction is substantially transverse to the first direction;
(b) a wheel positioning mechanism configured for selectively lowering or raising the first set of wheels or the second set of wheels into engagement or disengagement with the track system; and
(c) the container lifting mechanism of claim 1.

17. A storage and retrieval system comprising:
one or more stacks of storage containers, at least one storage container in the stack of storage containers comprising an insert nested in the storage container to define a container unit, the insert comprising an insert base and opposing insert sidewalls extending upwardly from the insert base;
a grid framework structure, the grid framework structure comprising:
(i) a supporting framework structure comprising a plurality of storage columns, each of the plurality of storage columns being arranged to accommodate a stack of storage containers;
(ii) a track system comprising a first set of tracks and a second set of tracks, the first set of tracks extending in a first direction and the second set of tracks extending in a second direction, the second direction being substantially perpendicular to the first direction, to form a grid pattern defining a plurality of grid cells, wherein each stack of container units is arranged below a grid cell; and
one or more load handling devices operable on the track system for lifting and moving storage containers stacked in the stacks, each of the one or more load handling devices comprising the load handling device of claim 16.

18. The system of claim 17, wherein the insert comprises at least one end opening for allowing one or more items to enter or exit the insert in a horizontal direction via the at least one end opening.

19. The system of claim 17, further comprising an item moving device associated with at least one of the plurality of storage columns, the item moving device being configured to move an item in the horizontal direction onto the insert base via the at least one end opening of the insert by moving the item in the horizontal direction through the at least one of the plurality of storage columns.
